(19) United States
(12) Patent Application Publication
(10) Pub. No.: US 2013/0290902 A1
(43) Pub. Date: Oct. 31, 2013

(54) USER CONTROL INTERFACE FOR AN APPLIANCE, AND ASSOCIATED METHOD

(71) Applicant: Electrolux Home Products, Inc., Charlotte, NC (US)

(72) Inventors: Robert Henry Martin, Charlotte, NC (US); Hayoung Coffman, Charlotte, NC (US); Novella Pennacchio, Porcia (IT)

(73) Assignee: Electrolux Home Products, Inc.

(21) Appl. No.: 13/931,407

(22) Filed: Jun. 28, 2013

Related U.S. Application Data
(63) Continuation of application No. PCT/US2011/067756, filed on Dec. 29, 2011.
(60) Provisional application No. 61/428,426, filed on Dec. 30, 2010.

(51) Int. Cl. G06F 3/0484; G06F 3/0485

(52) U.S. Cl. CPC G06F 3/04842; G06F 3/0485
USPC 715/823; 715/830

(57) ABSTRACT

A touchscreen user interface and associated method are provided for controlling a laundry appliance. The laundry appliance includes a controller device configured to direct operation of at least one operational component associated with the laundry appliance in response to at least one user selection via a touchscreen user interface in communication with the controller device. The touchscreen user interface has a display screen for displaying a series of main laundry cycle icons, each main laundry cycle icon being associated with a respective main laundry cycle capable of being implemented via the controller device. The series of main laundry cycle icons are scrollable across the display screen in opposing first and second scrolling directions, and each main laundry cycle icon is individually selectable as one of the at least one user selection via user touch interaction with the touchscreen user interface.

### CROSS-REFERENCE TO RELATED APPLICATION

This is a continuation application of International Application No. PCT/US2011/067756, filed Dec. 29, 2011, which International Application was published by the International Bureau in English on Jul. 5, 2012, which claims priority to U.S. Provisional Patent Application No. 61/428,426, which was filed on Dec. 30, 2010, which are both hereby incorporated herein in their entirety by reference.

### BACKGROUND

1. Field of the Disclosure

Aspects of the present disclosure relate generally to appliances and, more particularly, to a user control interface for a laundry appliance and an associated method for controlling a laundry appliance.

2. Description of Related Art

Certain laundry appliances, such as a washing machine or dryer, may include a controller or other control unit in electrical communication with one or more user interfaces or other control elements. Various operational components of the laundry appliance are thus controlled via the controller/control unit in response to various commands or user selections for controlling such components initiated through the user interface/control elements.

In some instances, the user interface may include various configurations of actuatable elements for permitting user selection from among a plurality of main laundry cycles and/or other parameters associated with the main laundry cycles. For example, a rotational-selection knob may be provided on a control panel of the laundry appliance, wherein the user rotates the selection knob to the desired laundry cycle or cycle segment, and then actuates an actuator to initiate the laundry cycle. In some instances, another physical button or knob may be provided for altering one or more of the default settings associated with the selected main laundry cycle. Such configurations of physical elements, however, may only provide limited usability and user-friendliness for the user. For example, only a limited number of laundry cycles may be provided due to physical constraints (e.g., size) of the control interface or selection device of the laundry appliance. Further, such configurations may not necessarily allow for personalization or customization of the laundry appliance to correspond to the preferences of the user or users.

Thus, it would be desirable to provide a control interface and associated method for controlling a laundry appliance with improved usability and user-friendliness. Such a solution should also be capable of implementing control configurations which are intuitive to the user, while providing more or a variety of options to the user. Further, such a solution should desirably provide personalization and customization capabilities such that one or more users can customize the laundry appliance for personal use, and should desirably do so in a functionally practical manner.

### BRIEF SUMMARY

The above and other needs are met by the present disclosure which, according to one aspect, provides a laundry appliance having a controller device configured to direct operation of at least one operational component associated with the laundry appliance. Such a laundry appliance further includes a touchscreen user interface in communication with the controller device, wherein the controller device is responsive to at least one user selection via the touchscreen user interface to direct operation of the at least one operational component. The touchscreen user interface has a display screen for displaying a series of main laundry cycle icons, each main laundry cycle icon being associated with a respective main laundry cycle capable of being implemented via the controller device. The series of main laundry cycle icons are scrollable across the display screen in opposing first and second scrolling directions, and each main laundry cycle icon is individually selectable as one of the at least one user selection via user touch interaction with the touchscreen user interface.

Another aspect of the present disclosure provides a method of controlling a laundry appliance. Such a method comprises displaying a series of main laundry cycle icons on a display screen of a touchscreen user interface associated with the laundry appliance. The touchscreen user interface is in communication with a controller device configured to direct operation of at least one operational component associated with the laundry appliance in response to at least one user selection via the touchscreen user interface. Each main laundry cycle icon is associated with a respective main laundry cycle capable of being implemented via the controller device and is individually selectable as one of the at least one user selection via user touch interaction with the touchscreen user interface. Such a method further comprises scrolling the series of main laundry cycle icons across the display screen in one of a first and second scrolling direction.

The foregoing presents a simplified summary of some aspects of this disclosure in order to provide a basic understanding. The foregoing summary is not extensive and is not intended to identify key or critical elements of the invention or to delineate the scope of the invention. The purpose of the foregoing summary is to present some concepts of this disclosure in a simplified form as a prelude to the more detailed description that is presented later. For example, other aspects will become apparent from the following.

### BRIEF DESCRIPTION OF THE SEVERAL VIEWS OF THE DRAWING(S)

Having thus described some aspects of the disclosure in general terms, reference will now be made to the accompanying drawings, which are not necessarily drawn to scale and may be schematic, and wherein:

FIG. 1 is a perspective view of a washing appliance control panel having a touchscreen user interface, according to one aspect of the present disclosure;

FIGS. 2-5 illustrate a washing appliance touchscreen user interface displaying a series of selectable and scrollable main wash cycle icons, according to one aspect of the present disclosure;

FIGS. 6-8 illustrate a washing appliance touchscreen user interface displaying a plurality of selectable option icons, according to one aspect of the present disclosure;

FIGS. 9 and 10 illustrate a washing appliance touchscreen user interface displaying a cycle settings tab configured to facilitate selection of a cycle parameter associated with a main wash cycle, according to one aspect of the present disclosure;

FIG. 11 illustrates a washing appliance touchscreen user interface displaying a personalized main wash cycle icon among a series of default main wash cycle icons, according to one aspect of the present disclosure;

FIG. 12 illustrates a washing appliance touchscreen user interface displaying a manage users tab, according to one aspect of the present disclosure;

FIGS. 13 and 14 illustrate a washing appliance touchscreen user interface displaying a wash cycle status display, according to one aspect of the present disclosure;

FIG. 15 illustrates a dryer appliance touchscreen user interface displaying a series of selectable and scrollable main drying cycle icons, according to one aspect of the present disclosure;

FIG. 16 illustrates a dryer appliance touchscreen user interface displaying a cycle settings tab configured to facilitate selection of a cycle parameter associated with a main drying cycle, according to one aspect of the present disclosure;

FIG. 17 illustrates a dryer appliance touchscreen user interface displaying a plurality of selectable option icons, according to one aspect of the present disclosure;

FIG. 18 illustrates a dryer appliance touchscreen user interface displaying a drying cycle status display, according to one aspect of the present disclosure;

FIG. 19 illustrates a washing appliance touchscreen user interface displaying an error image, according to one aspect of the present disclosure;

FIG. 20 illustrates a washing appliance touchscreen user interface displaying an attention image, according to one aspect of the present disclosure;

FIG. 21 illustrates a washing appliance touchscreen user interface displaying a series of selectable and scrollable main wash cycle icons, according to one aspect of the present disclosure;

FIG. 22 illustrates a washing appliance touchscreen user interface displaying a pause display, according to one aspect of the present disclosure;

FIG. 23 illustrates a washing appliance touchscreen user interface displaying a guides tab, according to one aspect of the present disclosure; and

FIG. 24 illustrates a washing appliance touchscreen user interface displaying a system settings tab, according to one aspect of the present disclosure.

### DETAILED DESCRIPTION

The present disclosure now will be described more fully hereinafter with reference to the accompanying drawings, in which some, but not all aspects of the disclosure are shown. Indeed, this disclosure may be embodied in many different forms and should not be construed as limited to the aspects set forth herein; rather, these aspects are provided so that this disclosure will satisfy applicable legal requirements. Like numbers refer to like elements throughout.

A laundry appliance (e.g., a washing appliance or a dryer appliance) typically includes a tub portion, supported within an enclosure, in which laundry may be placed for washing and/or drying. The tub portion may also define an access opening, whether about an upper surface or a forward surface thereof. A door assembly may be pivotably engaged with the tub portion or the enclosure so as to selectively permit access to the interior of the tub portion via the access opening. A washing or drying drum is rotatably disposed within the tub portion of the respective washing and drying appliance for agitating or spinning the laundry during the washing or drying process. The laundry appliance includes particular operational components (e.g., pumps, valves, motors, etc.) for performing the operational functions thereof.

The laundry appliance may typically include a number of selectable main laundry cycles, each representing a particular combination of various operational parameters associated with the laundering process. Such main laundry cycles may be selectable by a user on a touchscreen controller interface in communication with a controller device, wherein the controller device may be housed within a control panel 100 associated with the laundry appliance, or otherwise within the enclosure thereof. The controller device may include or be in communication with a control circuit configured to vary the parameters of the appropriate components of the laundry appliance required to execute the main laundry cycle selected by the user. That is, the controller device is configured to direct operation of at least one operational component associated with the laundry appliance in response to the main laundry cycle or other parameters selected by the user.

In some instances, the user may select the main laundry cycle by, for example, touching or otherwise actuating a virtual button or icon displayed on the touchscreen user interface 150, wherein the icon is associated with the desired main laundry cycle. Upon actuation of the desired icon, a signal associated with the corresponding main laundry cycle is directed to the control circuit for processing, wherein the controller device or other computer device is responsive to the signal to direct the various laundry appliance components to effectuate the parameters associated with the selected main laundry cycle. Such parameters may include, for example, particular durations for each laundry cycle segment/event (e.g., a fill event, a rinse event, a spin event, a drying event) of the main laundry cycle, the temperature of the water/air used by such segments/events, and the amount of water used during such wash segments/events. Accordingly, such parameters may be adjusted and controlled by the control circuit, including the controller device or other associated computer device, in communication with the laundry appliance components, as will be appreciated by one skilled in the art.

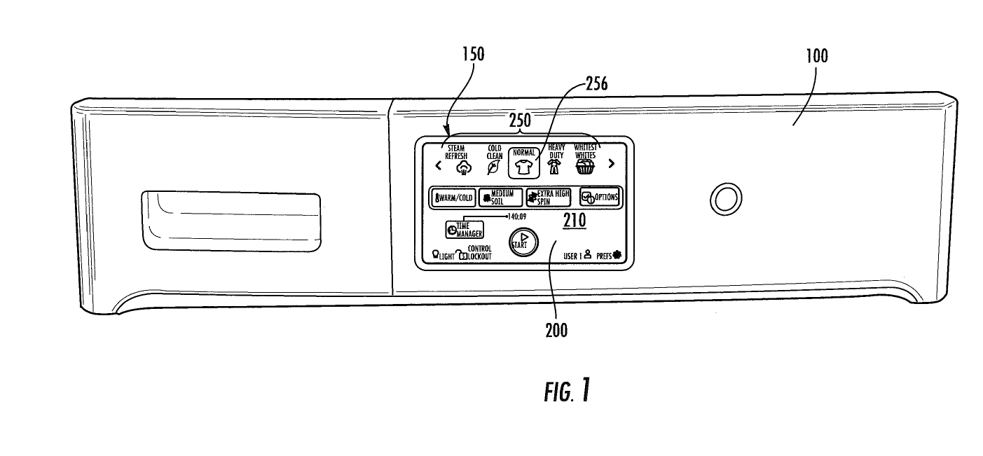

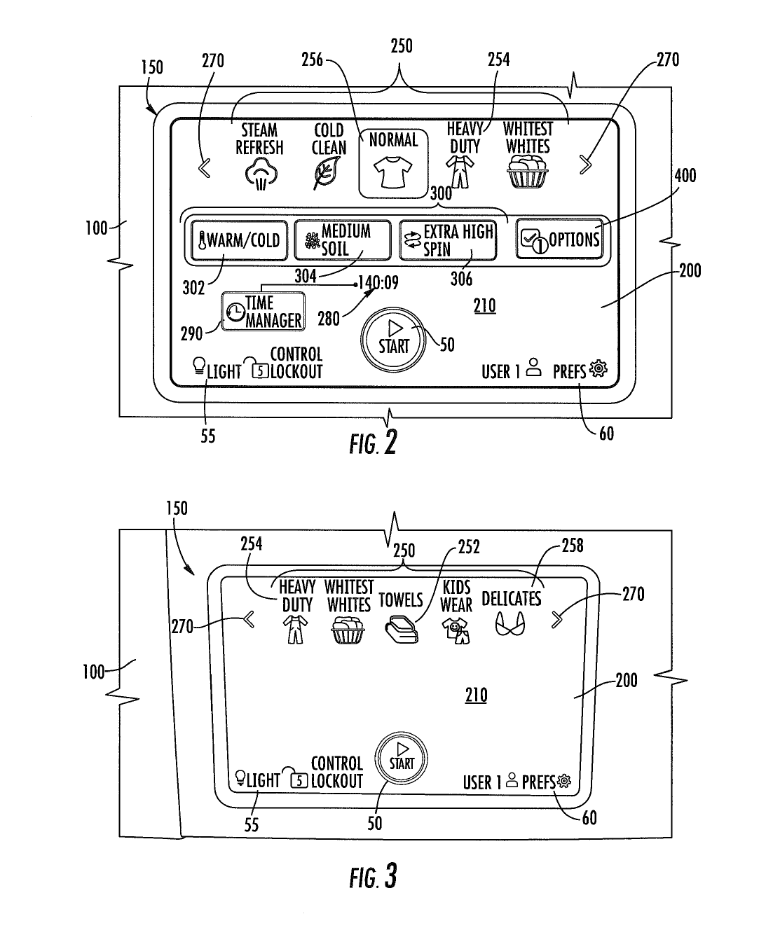

As disclosed, at least a portion of the controller device may be housed in or otherwise be in communication with a control panel 100 having a touchscreen user interface 150, as shown in FIG. 1. A user interacts with the touchscreen user interface 150 via, for example, a display screen or display portion 200, to, for instance, select a main laundry cycle, alter cycle parameters associated with a selected main laundry cycle, or initiate/stop/pause a laundry cycle. The display portion 200 of the touchscreen user interface 150 may comprise a liquid crystal display (LCD) or other display device capable of providing graphics/images to the user. In some instances, the display portion 200 may be backlit by one or more lighting devices such as, for example, a light emitting diode (LED) device. In some instances, the touchscreen user interface 150 may be configured to present a plurality of virtual buttons or icons. Each icon may be configured to include graphics and/or text (i.e., a string of alphanumeric characters) to provide the user with an indicia of a position on or area of the display screen with which the user may interact (i.e., touch) in order to select the corresponding icon. In some instances, the icon may have the appearance on the display portion 200 of a physical button (i.e., via three-dimensional graphics imaging), while in other instances the icon may only appear as text, a graphic, or combinations thereof on the display portion 200. According to some aspects, the icon selected by the user, or otherwise configured as a default icon, may be a visually-distinguished, highlighted or otherwise visually indicated or distinguished as being selected on the display portion 200, as shown in FIGS. 1 and 2 (illustrating a Normal main wash cycle icon 256 as being selected via highlighting, which is schematically represented by a circumscribing line). In some aspects, the icons may include animation to further provide an indication to the user, for example, the selection of an icon, the location of an icon, or to otherwise a position or area on the display portion defining an icon. Furthermore, in response to the selection of an icon, an aural indicia may be provided via an audio device and/or haptic feedback may be provided to the user via the display portion 200, as a confirmation of that selection.

As shown and disclosed herein, FIGS. 1-14 illustrate an exemplary control panel 100 and touchscreen user interface 150 for a washing appliance, while FIGS. 15-18 illustrate an exemplary control panel 100 and touchscreen user interface 150 for a dryer appliance. As such, the general aspects disclosed herein with respect to either the washing appliance touchscreen user interface or the dryer appliance touchscreen user interface may be applicable to both the washing and dryer appliances, as will be appreciated by one skilled in the art.

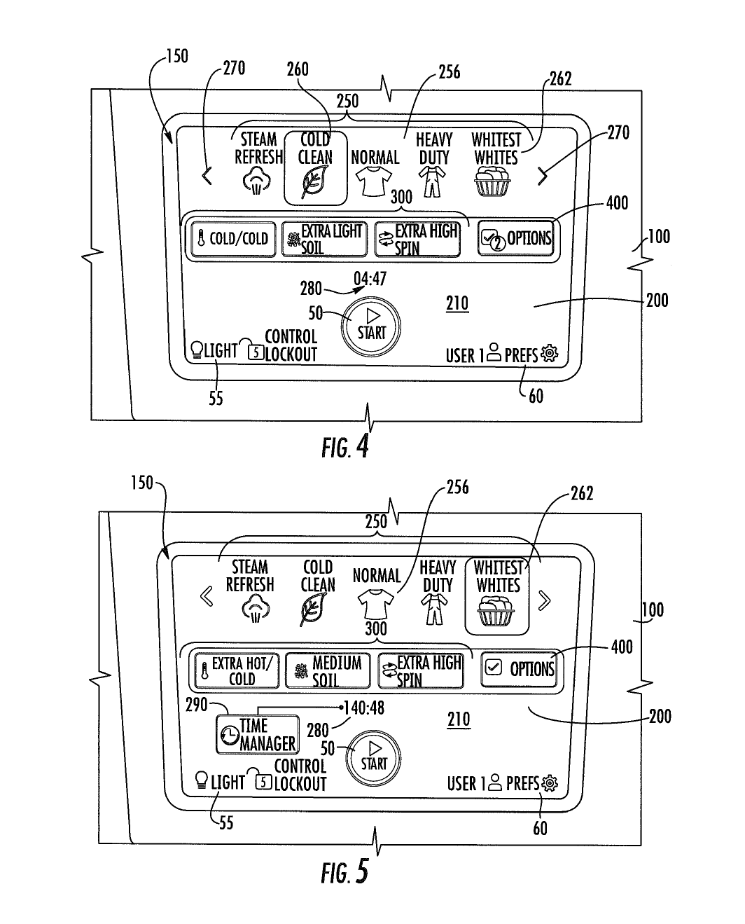

As shown in FIGS. 1-5 and 11, a default arrangement provided on the touchscreen controller interface 150/display portion 200 may include a main menu (home screen) display 210. The main menu display 210 on the display portion 200 may include a plurality of icons associated with the main wash cycles and other wash- or machine-related icons (e.g., wash cycle initiation/cycle start icon 50, light icon 55, preferences icon 60, etc.). According to some particular aspects of the present disclosure, the main menu display 210 on the display portion 200 may present a plurality of selectable main wash cycle icons 250 (e.g., Normal, Heavy Duty, Whitest Whites, Towels, Kids Wear, Delicates, Ultra Delicate, Handwash, Wool, Silk, Clean Washer, Rinse & Spin, Active Wear, Express Sanitize, Bulky/Bedding, Casual, Express Wash, Steam Refresh, and Cold Clean), each associated with a respective main wash cycle and being selectable by the user to select the desired main wash cycle. In some instances, each main wash cycle icon 250 includes text and/or a graphic particularly indicative of the associated main wash cycle. For example, the main wash cycle recommended or otherwise configured as the default for towels may be have displayed the text “Towels” in addition to an image or graphic of one or more towels, to form the Towel main wash cycle icon 252, as shown in FIG. 3. A variety of different icons, texts and/or graphics are within the scope of this disclosure. For example, for the cold clean icon (designated by numeral 260 in FIG. 4), its graphic may comprises a snowflake rather than the leaf which is shown, for example, in FIGS. 1 and 2.

In some instances, the main wash cycle icons 250 may be displayed on the display portion 200 in a series or otherwise linearly along a horizontally-displayed row or a vertically-displayed column. According to some aspects, the main wash cycle icons 250 may be displayed in multiple series on the display portion 200, in rows, columns, or combinations thereof. That is, a first series of the main wash cycle icons 250 could be provided on one side of the display portion 200, while a second series of main wash cycle icons 250 could be provided on the opposing side of the display portion 200, in rows, columns, or a combination thereof.

According to some aspects of the present disclosure, only a limited (i.e., less than the total amount of main wash cycle icons) or a predetermined amount of the main wash cycle icons 250 within the series may be visibly displayed on the display portion 200 at any time. For example, as shown in FIG. 2, only five main wash cycle icons 250 (Steam Refresh, Cold Clean, Normal, Heavy Duty, and Whitest Whites) are displayed on the display portion 200 concurrently, while one or more of the other main wash cycles remain available for selection. However, the one or more of the other main wash cycle icons 250 are not visibly displayed on the display portion 200. One skilled in the art will appreciate, though, that this exemplary configuration is not intended to limit the present disclosure. In this regard, any number of main wash cycle icons 250 may be concurrently displayed on the display portion 200 at any time, including all available main wash cycle icons 250 in the series.

In instances where only a predetermined amount of main wash cycle icons 250 are displayed concurrently (i.e., one or more of the other main wash cycles are available for selection, but are not displayed), the series of main wash cycle icons 250 may be configured to be scrollable with respect to the display portion 200 such that the user can scroll through the main wash cycle icons 250 to view the non-displayed others of the main wash cycle icons 250. That is, the series of main wash cycle icons 250 may be laterally (rows) or vertically (columns) scrollable, in either direction, to allow the user to view or otherwise scroll among the series of main wash cycle icons 250. In this regard, the series of main wash cycle icons 250 may be scrollable in either direction. For example, as illustrated in FIGS. 2 and 3, a Heavy Duty main wash cycle icon 254 is moved across the screen in one scrolling direction as the series of main wash cycle icons 250 is scrolled, and a Normal main wash cycle icon 256 disappears from the display portion 200, while a Delicates main wash cycle icon 258 visibly appears on the display portion 200.

According to one aspect, a directional icon 270 may be displayed on opposing sides of the predetermined number of main wash cycle icons 250 visible on the display portion 200. In this regard, the user may interact (i.e., touch) the directional icons 270 to scroll the main wash cycle icons 250 in respective direction. In other instances, the user may scroll the series of main wash cycle icons 250 by use of a swiping/brushing motion across the display portion 200 in either scrolling direction. That is, for example, the user may touch the display portion 200 with a finger, in the proximity of the series of main wash cycle icons 250, and then drag/swipe/brush the finger across the display portion 200 in a scrolling direction to thereby cause the series of main wash cycle icons 250 to scroll in the selected scrolling direction. In some instances, the intensity of the swiping/brushing motion by the user in the scrolling direction may determine or otherwise affect the extent to which the series of main wash cycle icons are scrolled. For example, a quick swiping motion may cause scrolling through a relatively large number of the main wash cycle icons 250, while a light or slow swiping motion may only cause scrolling through a relatively small number of the main wash cycle icons 250.

In some aspects of the present disclosure, the series of main wash cycle icons 250 may be continuously or infinitely scrollable in either scrolling direction through interaction with one of the directional icons 270 or swiping/brushing the series of main wash cycle icons 250 in a single scrolling direction. In other instances, the series of main wash cycle icons 250 may scrollable only to the respective ends of the series such that, through interaction with one of the directional icons 270 or by swiping/brushing the series of main wash cycle icons 250 in a single scrolling direction, the scrolling of the series of main wash cycle icons 250 is stopped at the last main wash cycle icon 250 in the particular scrolling direction, wherein the main wash cycle icons 250 cannot be scrolled any further in that particular scrolling direction.

According to some aspects of the present disclosure, an initial selection of one of the main wash cycle icons 250 displayed on the display portion 200 causes primary parameter icons 300, associated with the selected main wash cycle, to be displayed on the display portion 200, as shown in FIG. 2. In some instances, the series of main wash cycles may include a designated default main wash cycle such as, for example, a “Normal” main wash cycle. In those instances, an initial display on the display portion 200 may include the default “Normal” main wash cycle being highlighted or otherwise distinguished, with the primary parameter icons 300 being displayed adjacent thereto on the display portion 200. The primary parameter icons 300 may be indicative of parameters common to all of the main wash cycles, such as, for example, the water temperature, the soil level of the laundry, and the spin rate. In some instances, the primary parameter icons 300 may be displayed adjacent to the series of main wash cycle icons 250. For example, as shown in FIGS. 2, 4 and 5, the primary parameter icons 300 may be displayed vertically-adjacent to a horizontal row of the selectable main wash cycle icons 250. The primary parameter icons 300 may be set to default values of each respective main wash cycle such that, upon selection of a particular main wash cycle by a user via the associated main wash cycle icon 250, the primary parameter icons 300 reflect the default values of that particular main wash cycle. For example, as shown in FIG. 2, a selection of the Normal main wash cycle icon 256 causes the primary parameter icons 300 to display the default values associated therewith such as, for example, a water temperature parameter icon 302 (e.g., Warm/Cold), a soil level parameter icon 304 (e.g., Medium Soil), and an spin rate parameter icon 306 (e.g., Extra High Spin) as the default values when the Normal main wash cycle icon 256 is selected. The default values of the primary parameter icons 300, associated with the main wash cycle, may be indicated using textual indicia, numerical indicia, or any other suitable indicia. Further, the primary parameter icons 300 may display appropriate graphics (e.g., a thermometer for the water temperature parameter) for indicating to the user the particular parameter associated with the primary parameter icon 300.

According to some aspects of the present disclosure, the primary parameter icons 300 may only be displayed on the display portion 200 when the associated and initially-selected or default main wash cycle icon 250 is displayed on the display portion 200. In this regard, scrolling the series of main wash cycle icons 250 such that the initially-selected or default main wash cycle icon 250 is moved off the display portion 200, in turn, causes the primary parameter icons 300 associated with the initially-selected or default main wash cycle icon 250 to also be removed from the display portion 200. For example, as shown in FIG. 2, the Normal main wash cycle icon 256 may be selected by the user or designated as a default main wash cycle (and a visually-distinguished/highlighted as described previously), thereby causing the associated primary parameter icons 300 to be displayed with the corresponding default values. As shown in FIG. 3, upon scrolling the Normal main wash cycle icon 256 off the display portion 200, the primary parameter icons 300 associated therewith are no longer displayed on the display portion 200 (i.e., disappear from or are removed from the display portion 200). In summary, once a selected or default main wash cycle icon 250 is scrolled off the display portion 200, the associated primary parameter icons 300 are removed or disappear from the display portion 200. Conversely, should the selected or default main wash cycle icon be scrolled back onto the display portion 200, the associated primary parameter icons 300 will also re-appear on the display portion 200.

In some aspects, even though the primary parameter icons 300 are removed or disappear from the display portion 200, and the initially-selected or default main wash cycle icon 250 is not displayed on the display portion 200, the selected or default main wash cycle can still be initiated by actuating a wash cycle initiation icon (e.g., the cycle “Start” icon 50). For example, as illustrated by FIGS. 2 and 3, after the Normal main wash cycle icon 256 has been selected (or is otherwise indicated as the default selection) and then scrolled off the display portion 200, the wash cycle initiation icon 50 may still be actuated to initiate the washing procedure based on the Normal main wash cycle.

According to some aspects, as illustrated by FIGS. 4 and 5, selecting a different main wash cycle icon 250 displayed on the display portion 200 (other than the default selection) may cause the default values of the primary parameter icons 300 to change from those of the initially-selected or default main wash cycle, to the default values of the different main wash cycle. For example, when changing from the Cold Clean main wash cycle (i.e., the Cold Clean main wash cycle icon 260 is selected) to the Whitest Whites main wash cycle (i.e., the Whitest Whites main wash cycle icon 262 is selected), the default values of the primary parameter icons 300 change, as follows: the water temperature parameter changes from Cold/Cold to Extra Hot/Cold, and the soil level parameter changes from Extra Light Soil to Medium Soil. In this particular instance, the default value associated with the spin rate parameter remains unchanged.

In some instances, if the displayed default values of the primary parameter icons 300 of the initially-selected or default main wash cycle may change to the default values of the primary parameter icons 300 of the subsequently selected main wash cycle, such changes in the primary parameter icons 300 may be indicated to the user via a scrolling mechanism. For example, similarly to the main wash cycle icons, each of the primary parameter icons 300 may have a particular amount of possible parameter values associated therewith, wherein the possible parameter values may be arranged in a series. As such, upon the parameter value of a primary parameter change due to the selection of a different main wash cycle, the change in parameter value may be indicated by the primary parameter icon 300 scrolling from an initial parameter value to the new parameter value, across any parameter values in the series that may be disposed therebetween. In another example, the scrolling of the parameter values of the primary parameter icons 300 may be similar to that of a slot machine, wherein the indicia associated with the parameter values of the particular primary parameter icon 300 appear to be associated with a horizontally-disposed rotatable cylinder, such that the parameter values appear to vertically roll in conjunction with the rotation of the cylinder as the respective parameter value changes. That is, in one example presented above, the Cold/Cold indicia displayed on the primary parameter icon 300 associated with the water temperature parameter would scroll off the primary parameter icon 300, while the Extra Hot/Cold indicia would scroll onto the primary parameter icon 300 upon the change in parameter value due to the selection of the different main wash cycle. One skilled in the art will appreciate that, in other instances, the scrolling of the indicia associated with the parameter values of the primary parameter icons 300 may occur in many different manners. For example, the parameter values associated with any primary parameter icon 300 may be represented by a series of discrete images that successively appear on the display portion 200 in association with the respective primary parameter icon 300 when the parameter value is changed.

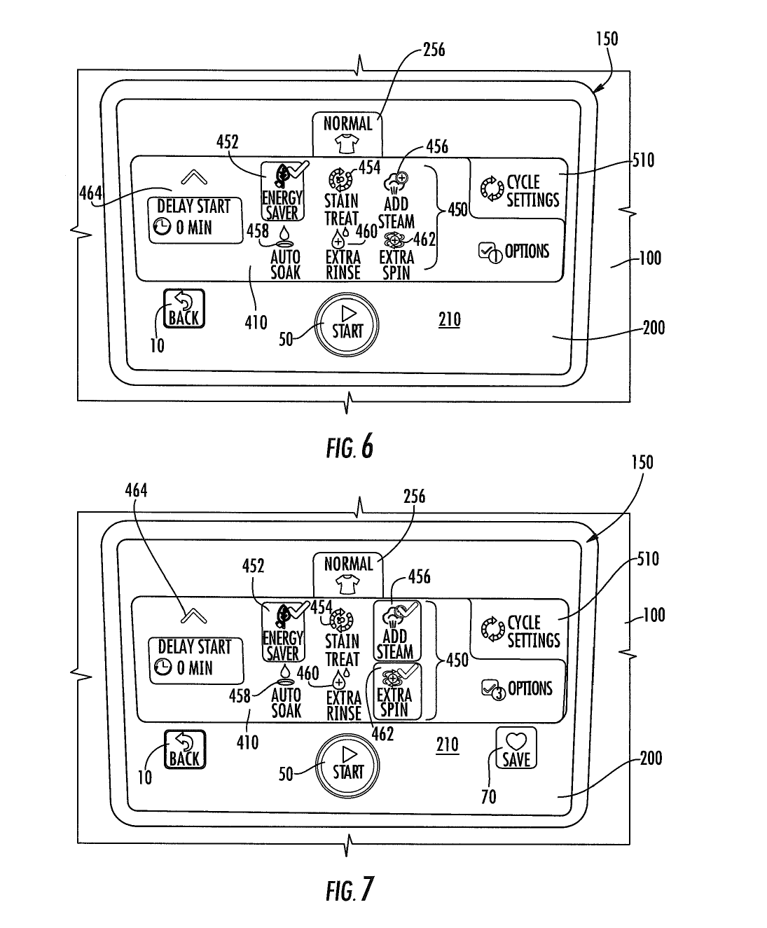

According to some aspects of the present disclosure, an “Options” icon 400 may be displayed on the display portion 200 in conjunction with the default main wash cycle, or when one of the main wash cycle icons 250 is selected by the user. In some instances, the Options icon 400 may be displayed on the display portion 200 adjacent to the primary parameter icons 300. Referring to FIGS. 6 and 7, the Options icon 400 may be actuatable to display, on the display portion 200, a plurality of selectable option icons 450, other than the primary parameters, associated with the selected main wash cycle. For example, actuation of the Options icon 400 may cause an options tab 410 to be displayed on the display portion 200, wherein the options tab 410 includes the plurality of selectable option icons 450 displayed therewith. The selectable option icons 450 may include, for example, an Energy Saver option icon 452, a Stain Treat option icon 454, an Add Steam option icon 456, a Pre-Wash or Auto Soak option icon 458, an Extra Rinse option icon 460, and an Extra Spin option icon 462. According to some aspects, the wash cycle initiation icon 50 may remain displayed and actuatable to initiate the selected main wash cycle when the options tab 410 is selected and displayed.

In some instances, the options tab 410 may be included on the main menu display such that the main menu display 210 is in the background on the display portion 200. Further, in some aspects, upon actuation of the Options icon 400, only the selected main wash cycle icon 250 from the series of selectable main wash cycle icons 250 is displayed. The selected main wash cycle icon 250 may also be “grayed out” adjacent to the options tab 410. For example, as illustrated in FIGS. 6 and 7, the Normal main wash cycle icon 256 is shown as selected and thus appears as the only visible main wash cycle icon 250, albeit grayed out, when the Options icon 400 is actuated to display the options tab 410. In some aspects, actuation of the Options icon 400 may also cause a return/back icon 10 to be displayed, wherein the return/back icon 10 may be actuated to return to the main menu display 210 (i.e., the options tab 410 is removed and the Options icon 400 restored). In addition, actuation of the Options icon 400 may cause a “delay start” option icon 464 to be displayed in connection with the options tab 410. The delay start option icon 464 can be actuated using, for example, actuatable directional icons associated therewith to increase or decrease a time delay in the initiation of a selected main wash cycle, wherein the duration of the delay may be indicated via an appropriate alphanumeric indicia.

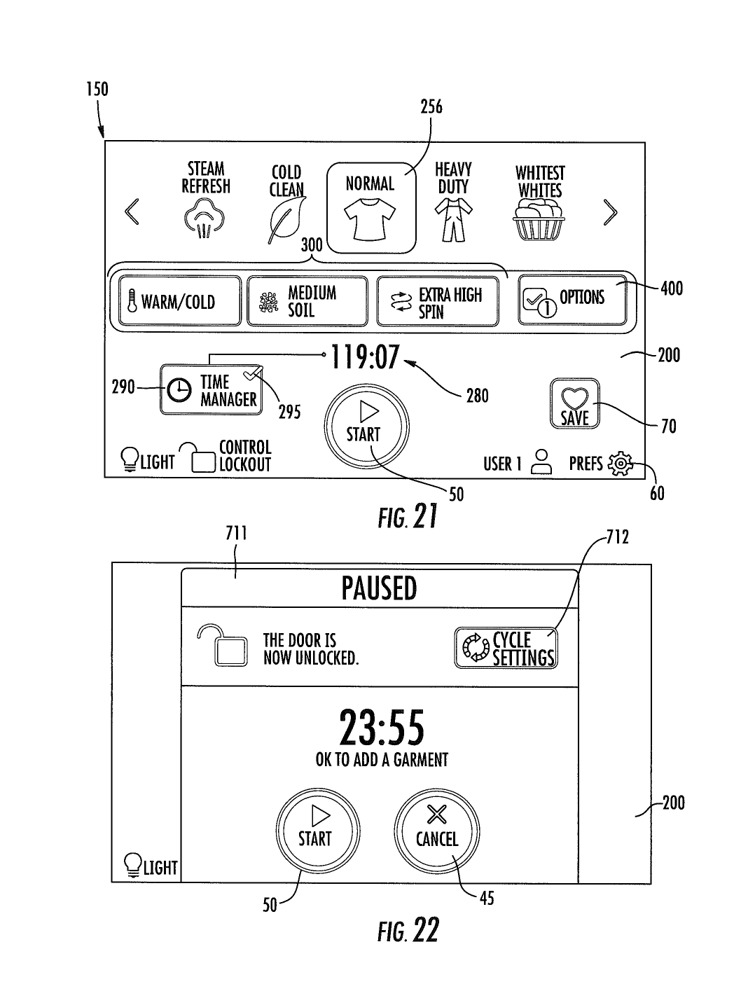

Further, in conjunction with the default/selected main wash cycle, a cycle time 280 associated with that main wash cycle may also be displayed on the display portion 200 in association therewith. For example and as shown in FIG. 4, the selection of the Cold Clean main wash cycle causes a cycle time 280 of 04:47 to appear on the display portion 200 adjacent to the primary parameter icons 300. Alternatively, the default/shown cycle time for the Cold Clean main wash cycle may be 00:48 minutes or any other suitable amount of time. In some instances, the default/selected main wash cycle may have different configurations that may allow the user to select from various cycle times 280. For example and as shown in FIGS. 1 and 2, the selection (or default) of the Normal main wash cycle causes a default cycle time 280 of 140:09 to appear on the display portion 200 adjacent to the primary parameter icons 300, or alternatively a default cycle time of 00:52 minutes or any other suitable amount may be displayed. In this instance, the additional display of a Time Manager icon 290 indicates to the user that other cycle times may be available for selection. As such, a series of user touch actuations of the Time Manager icon 290 causes the displayed cycle time 280 to endlessly scroll among the available cycle times. In some instances, for example, a check mark indicia may be displayed in association with the Time Manager icon 290 for any available cycle time that is not the default cycle time. For example, as shown in FIG. 21, for an alternate cycle time 280 of 119:07 minutes of the Normal main wash cycle, the alternate cycle time 280 is indicated as being selected via a check mark indicia 295 associated with the Time Manager icon 290.

In some instances, the Options icon 400 and/or the options tab 410 may include a numerical indicia associated therewith for indicating an amount of the selectable options included as additional default parameters associated with the selected main wash cycle and/or any of the other selectable options selected by the user. For example, the Options icon 400 and/or the options tab 410 may display a numerical indicia of one when the Normal main wash cycle icon 256 is selected (see, e.g., FIG. 2—one of the selectable options under the options tab 410 is included as one of the default parameters of the Normal cycle), a numerical indicia of two when the Cold Clean main wash cycle icon 260 is selected (see, e.g., FIG. 4), and no numerical indicia when the Whitest Whites main wash cycle icon 262 is selected (see, e.g., FIG. 5). In such instances, the numerical indicia that initially appears in connection with the Options icon 400 and/or the options tab 410 upon selection of a main wash cycle may represent the amount of selectable options associated with each respective main wash cycle (i.e., how many of the selectable options are included in the default parameters of the selected or default main wash cycle). The numerical indicia may be updated as other selectable options are selected/deselected by the user, and the user may also deselect any of the selectable options included in the default parameters of the selected or default main wash cycle. In some instances, actuating/de-actuating the delay start option icon 464 may further cause the displayed numerical indicia associated with the Options icon 400 and/or the options tab 410 to correspondingly increase or decrease. Selection of one of the selectable option icons 450 may cause that selected option icon 450 to be a visually-distinguished, highlighted or otherwise visually indicated as being selected when the user interacts therewith, as shown in FIGS. 6 and 7. In some instances, for example, a check mark indicia may be displayed in association with that selected option icon 450. For example, as shown in FIG. 7, the Energy Saver option icon 452, the Add Steam option icon 456, and the Extra Spin option icon 462 are indicated as being selected via both highlighting and a check mark indicia, and the numerical indicia associated with the Options icon 400 and/or the options tab 410 appropriately indicates that three selectable options are currently selected. The selected options icons may be visually identified as being selected in one or more suitable manners. For example, the highlighting and/or check mark indicia may be omitted.

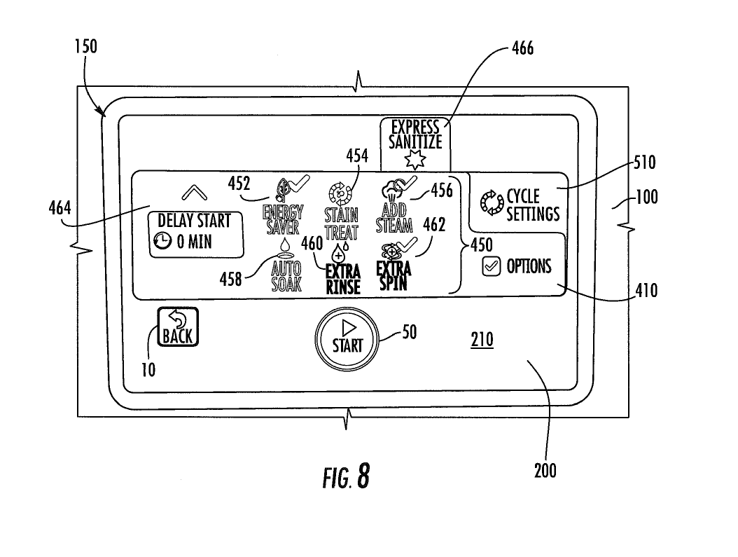

Further, according to some aspects, the selectable option icons 450 (e.g., the Energy Saver option icon 452, the Stain Treat option icon 454, the Add Steam option icon 456, the Auto Soak option icon 458, the Extra Rinse option icon 460, and the Extra Spin option icon 462, as shown in FIG. 7) for any selectable options not recommended or otherwise unavailable for a particular main wash cycle, may be rendered non-selectable, as necessary, in the selectable option icons 450 displayed in conjunction with the options tab 410. For example and referring to FIG. 8, selection of the Express Sanitize main wash cycle icon 466 may render the Energy Saver, Stain Treat, Add Steam, and Auto Soak option icons 450 non-selectable such that the only options available to be selected are the Extra Rinse and Extra Spin options. As shown in FIG. 8, the non-selectable options (the Energy Saver option, the Stain Treat option, the Add Steam option and the Auto Soak option) may be indicated by a “graying-out” of the textual/graphical indicia associated with the corresponding non-selectable option icon displayed in connection with the options tab 410. In this regard, in some instances, the contrast between the textual/graphical indicia of the non-selectable option icon and the options display tab 410 may be decreased such that the textual/graphical indicia is only dimly or faintly visible to the user. However, other visual indicia may be provided to indicate that a selectable option is not recommended or not available in conjunction with a selected main wash cycle. In some instances, an aural indicia (e.g., a beeping sound) may be provided to the user when attempting to interact with a non-selectable option to indicate that the particular option is not selectable in conjunction with the selected main wash cycle. As another example for other main wash cycles, the Stain Treat and Add Steam options may not be available while the Energy Saver option is selected, such that the Stain Treat and Add Steam icons 450, 456 are dimmed or otherwise “negatively” distinguished in response to selection of the Energy Saver icon 452.

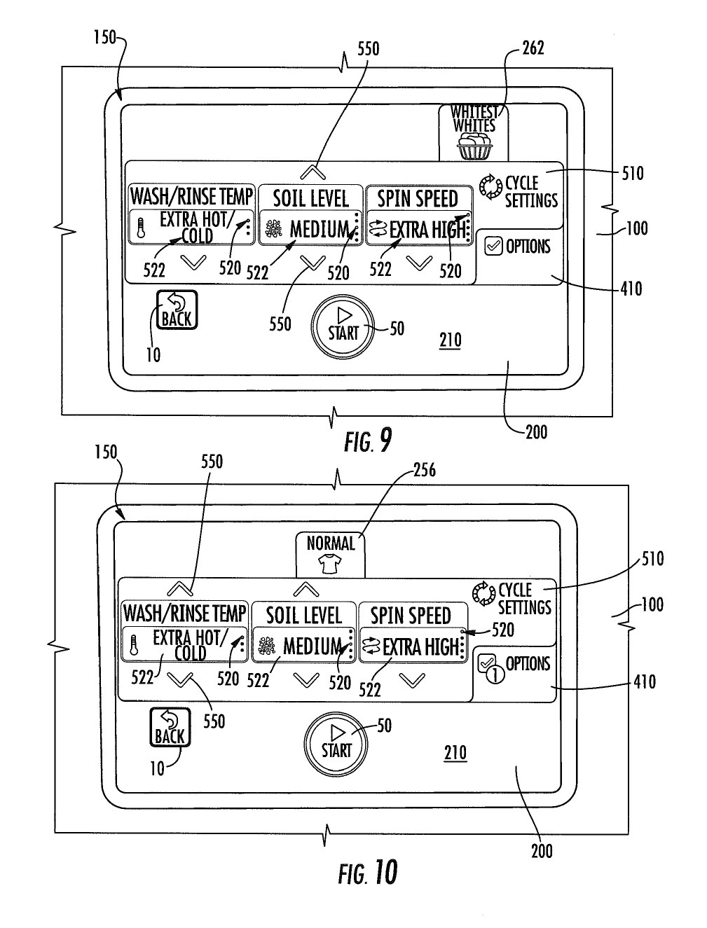

In some aspects, a selection of any one of the primary parameter icons 300 may cause an expanded display of the primary parameters to be displayed on the display portion 200 in association with, for example, a cycle settings tab 510, as shown in FIGS. 9 and 10. In some instances, at least a portion of the options tab 410 may also be displayed on the display portion 200 when the cycle settings tab 510 is displayed, as shown in FIGS. 8 and 9. As such, the user can interact with the displayed portion of the options tab 410 or the cycle settings tab 510 to toggle/switch between the cycle settings tab 510 and the options tab 410 for viewing/adjusting the respective parameters/options associated therewith. As shown in FIGS. 6-8, the same toggling aspect may also be provided when the Options icon 400 is selected to display the options tab 410. In this regard, at least a portion of the cycle settings tab 510 may be displayed on the display portion 200 when the options tab 410 is displayed, so as to allow the user to toggle/switch between the cycle settings tab 510 and the options tab 410 by interacting with the respective tab. In some instances, depending on the tab being selected, the selected tab and the icons associated therewith may appear to be superimposed on the non-selected tab and the options associated therewith, such that the user may only interact with one tab at any one time. In some aspects, however, the cycle settings display tab 510 may be disposed adjacent to the options display tab 410, and the user may interact with both tabs.

With reference to FIGS. 9 and 10, the expanded display of the primary parameters in conjunction with the cycle settings tab 510, may include any selectable values (e.g., parameter settings) associated with each primary parameter. For example, the water temperature parameter icon 302 may include the following selectable values: Hot/Cold, Warm/Cold, and Cold/Cold, wherein the first temperature indicia may be related to a wash water temperature and the second temperature indicia may be related to a rinse water temperature associated with the particular main wash cycle; the soil level parameter icon 304 may include the following selectable values: Extra Heavy, Heavy, Medium, Light, and Extra Light; and the spin cycle parameter icon 306 may include the following selectable values: Extra High, High, Medium, Low, and None. In some instances, a selection indicia 520 may be provided and displayed adjacent to a textual indicia 522 associated with each primary parameter, wherein the selection indicia 520 may be configured to indicate to the user a series of the selectable values available for each respective primary parameter, as well as the current selectable value in the series represented by the respective primary parameter icon 300. For example, the selection indicia 520 may be provided as a series of lightable elements, wherein the lightable element corresponding to the current selectable value is configured to be lit to indicate the current selectable value, and wherein the other lightable elements are configured to be lit in response to the selection of a different selectable value by the user. Any suitable number of selectable values and corresponding lightable elements are within the scope of this disclosure. That is, different or additional values may be included, such as Extra Hot/Cold and Warm/Warm for the water temperature parameter icon 302.

According to some aspects, a desired selectable value for each primary parameter associated with the cycle settings tab 510 may be selectable by way of associated directional icons 550 for scrolling through the series of selectable values. In some instances, the directional icons 550 may be displayed and provided in association with the cycle settings tab 510. In some aspects, the scrolling of the selectable values of the respective primary parameter may be similar to that of a slot machine, wherein the indicia associated with the selectable values of the particular primary parameter appear to be associated with a horizontally-disposed rotatable cylinder, such that the parameter values appear to vertically roll in conjunction with the rotation of the cylinder as the respective selectable value changes. For example, the textual indicia 522 associated with the water temperature primary parameter (e.g., the Hot/Cold, Warm/Cold, and Cold/Cold indicia associated with the water temperature primary parameter) may appear to vertically roll or otherwise move vertically with respect to the cycle settings tab 510.

In some aspects, as shown in FIG. 7, any change to the default values associated with the primary parameters and/or options may cause a save icon 70 to be displayed on the display portion 200. Selection of the save icon 70 by the user may further cause all currently-selected wash cycle parameters, including the currently-selected primary parameter values and/or options, as well as any unchanged/default parameter values for the selected main wash cycle, to be collectively saved as a user favorite main wash cycle. For example, as shown in FIG. 6, the default options for the Normal main wash cycle include only the Energy Saver option. However, as shown in FIG. 7, user-selection of the first selected one of the Add Steam and Extra Spin options causes the save icon 70 to be displayed on the display portion 200. As such, a personalized main wash cycle (based on the Normal main wash cycle and personal to the user's preferences) can be saved by the user for current and future use by the user. In some instances, the number of user favorite/personalized main wash cycles which can be saved by the user may be limited to a predetermined quantity, whereas in other instances, the number of user favorite/personalized main wash cycles that can be saved may be essentially unlimited.

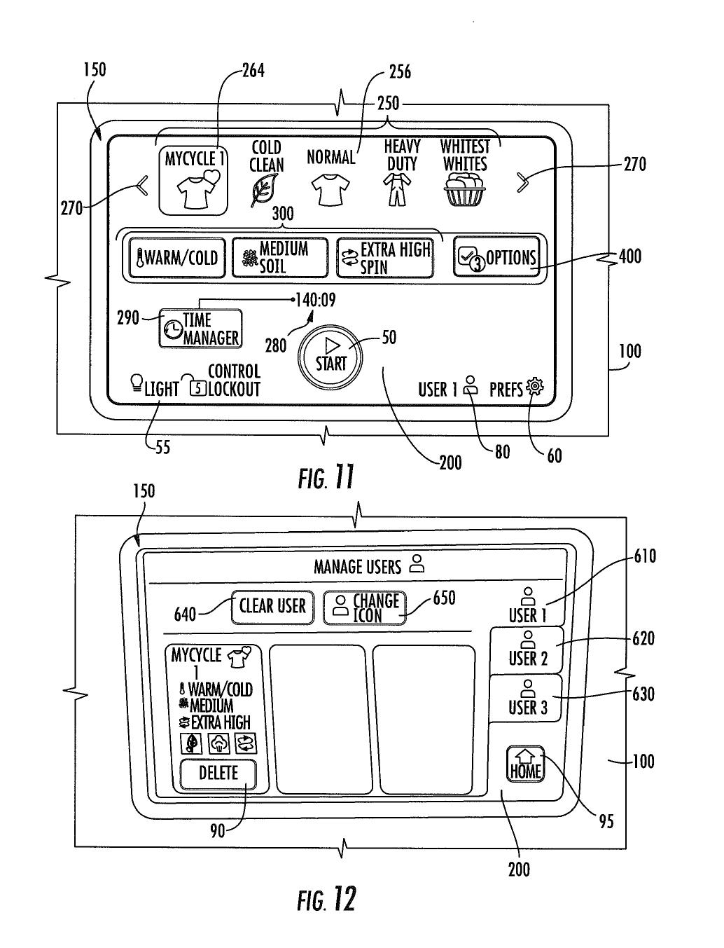

In accordance with saving a user favorite/personalized main wash cycle, as shown in FIG. 11, a user favorite icon 264 associated with the particular personalized main wash cycle may be added to the displayed series of main wash cycle icons 250 displayed on the display portion 200, upon selection of the save icon 70 (e.g., see FIG. 7) after any alterations of the default primary parameters/options of a main wash cycle. For example, the user favorite icon 264 (MyCycle 1) may be added to the series of selectable main wash cycle icons 250 after the user selects one or more options (e.g., the Add Steam and Extra Spin options) for addition to the Normal main wash cycle and then actuates the save icon 70. In some instances, the graphical indicia associated with the user favorite icon 264 may be similar to that of the graphical indicia associated with the main wash cycle icon 250 forming the basis of the user favorite/personalized main wash cycle. For example, as shown in FIG. 11, the user favorite icon 264 displays a similar graphical indicia as that of the Normal wash cycle icon 256 since the Normal main wash cycle was altered to form the personalized main wash cycle (e.g., the MyCycle 1 main wash cycle). The user favorite icon 264 may, however, be differentiated from the main wash cycle icon 250 forming the basis thereof, for instance, by the associated textual indicia and/or a distinguishing graphic such as, in one example, a heart indicia.

A user icon 80 that is displayed on the display portion 200 is shown in FIG. 11, and it is also shown in other figures, such as FIGS. 1-5, without its reference number 80. The touchscreen user interface 150 may accommodate different users, such as a “User 1”, “User 2” and “User 3”. Selecting the user icon 80 may cause a first Manage Users menu (not shown) to be displayed on the display portion 200. The first Manage Users menu displays user 1, user 2 and user 3 icons (not shown) and a Manage Users icon (not shown) on the display portion 200, and these icons may be selected between for establishing the present user of the appliance/touchscreen user interface 150 as one of the first, second and third users, or to transition to a second Manage Users menu. In response to selection of one of the user 1, user 2 and user 3 icons in the first Manage Users menu, the first Manage Users menu is replaced with the prior screen or menu on the display portion 200, and the appropriate one of “User 1”, “User 2” or “User 3” is displayed next to the user icon 80 to indicate which of the users is the present user of the appliance/touchscreen user interface 150. The touchscreen user interface 150 may accommodate a lesser or greater number of users.

Upon creation of one or more user favorite icons (e.g., the MyCycle 1 user favorite icon 264), user selection of the user icon 80 (FIG. 11) followed by user selection of the Manage Users icon of the first Manage Users menu may cause a second Manage Users menu to be displayed on the display portion 200, as shown in FIG. 12. Unless the user identification is changed via the user icon 80 and the first Manage Users menu, the previously disclosed functions heretofore disclosed, as well as subsequently disclosed, may be associated with “User 1.” For example, the previously saved MyCycle 1 user favorite wash cycle previously save by the user would not appear in the series of selectable main wash cycle options 250, if the user icon 80 was changed to reflect that any subsequent actions would be taken by User 2, User 3, . . . or User X.

The second Manage Users menu shown in FIG. 12 may allow the users to change or personalize various aspects associated with the user-created personalized main wash cycle(s), such as MyCycle 1, MyCycle 2, etc., through selection of user tabs 610, 620, 630. That is, in response to user selection of the user icon 80 followed by user selection of the Manage Users icon of the first Manage Users menu, a number of selectable user tabs 610, 620, 630 are displayed. For the user that is presently identified as being using the appliance/touchscreen user interface 150, the corresponding user tab may be displayed as being superimposed over the other user tabs.

Selection of the “User 1” tab 610 causes any personalized main wash cycle(s) created by User 1 to be displayed. Each displayed user-created personalized main wash cycle may include any of a textual identifier (e.g., MyCycle 1), a graphical icon, the selected values of the primary parameters, and any selected options, whether graphically and/or textually represented. Each displayed user-created personalized main wash cycle may also include a “Delete” icon to allow the user to delete the respective personalized main wash cycle, including the textual identifier and the associated user favorite icon. That is, regarding the example illustrated in FIG. 12, selecting the delete icon 90 would cause the MyCycle 1 main wash cycle and associated user favorite icon 264 to be deleted from the controller device.

The User 1 tab 610 may further include a “Clear User” icon 640 for allowing the user to delete all of the wash cycles saved by User 1, and a “Change Icon” icon 650 for allowing the user to change the default user icon 80/the icon representing the user associated with the User 1 tab. Any actuation of the “Change Icon” icon 650 would provide the user with a menu of selectable user icons (e.g., icons respectively shaped like the bust of a person (i.e., the default user icon 80), a car, a purse, a person wearing pants, and a person wearing a dress). In response to the first user selecting one of the selectable user icons, the selected user icon would be represented in typically each of the “Change Icon” icon 650, the icon associated with the User 1 tab, and the user icon 80 while User 1 is presently identified as being using the appliance/touchscreen user interface 150.

The additional user tabs 620, 630 (i.e., for User 2 and User 3) may be provided adjacent to or otherwise in conjunction with the User 1 tab 610, such that multiple users can create, save, and access their own personalized main wash cycles. In this regard, the user may be able to toggle/switch between the user tabs 610, 620, 630 by interacting with the desired tab displayed on the display portion 200. In some instances, a “Home” icon 95 may be displayed such that actuation or selection thereof causes the main menu display 210 to be displayed. In some instances, upon selection of the Home icon 95, the user corresponding to the last selected user tab will become the active user of the laundry appliance via the controller device. More particularly, if the User 2 tab 620 was the last selected user tab upon selection of the Home icon, User 2 would then be designated as the active user, and the subsequent main menu display 210 would include the default series of available main wash cycle icons 250 and any personalized main wash cycles saved by User 2 (i.e., the default series of available main wash cycle icons 250 for User 2 would not necessarily include the MyCycle 1 main wash cycle previously saved by User 1).

Upon the user determining the parameters of a desired wash program, including the appropriate main wash cycle, and any primary parameter changes or option selections, the start icon 50 displayed on the display portion 200 may be actuated by the user to initiate the selected main wash cycle. For example, regarding the illustration of FIG. 2, selecting or actuating the start icon 50 would cause the selected Normal main wash cycle to be actuated. As discussed previously, the start icon 50 may be user-actuated when any of the main menu display 210, the options tab 410, and the cycle settings tab 510 is displayed on the display portion 200.

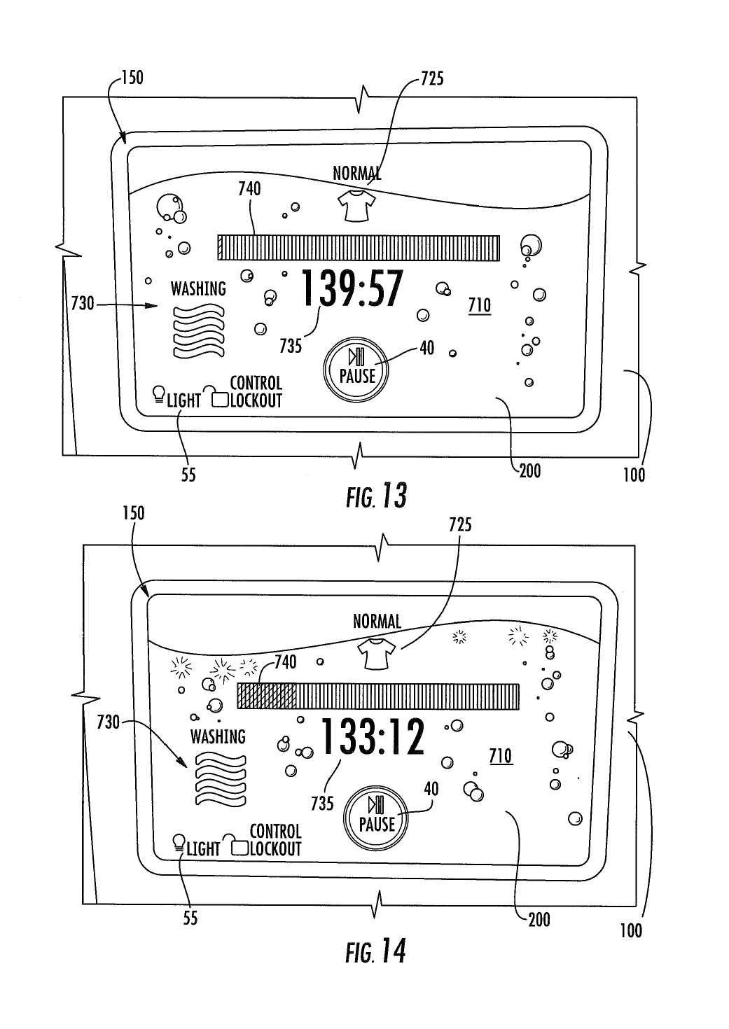

Upon actuation of the user-selected main wash cycle via the start icon 50, a wash cycle status display 710 may be displayed on the display portion 200, as shown in FIGS. 13 and 14. In some instances, various wash cycle status indicia may be displayed on the wash cycle status display 710. For example, the wash cycle status indicia may include an indicia of the selected main wash cycle 725, an indicia 730 indicative of the main wash cycle segment (e.g., fill, wash, rinse, spin, etc.) currently being performed and/or indicative of whether the main wash cycle segment is active, a wash cycle countdown timer 735, an indicia of cycle progress (i.e., elapsed time and/or time remaining) 740, and a user-selectable pause/stop icon 40. Regarding the wash cycle countdown timer 735, a variety of times different than those shown in the figures herewith or discussed herein are within the scope of this disclosure.

As shown in FIGS. 13 and 14, the wash cycle activity indicia 732 is displayed on the display portion 200 while a wash cycle is currently being performed, and the wash cycle activity indicia may comprise: a body of water, wherein the body of water may include an undulating upper surface and/or bubbles that rise toward the upper surface and pop/vanish proximate the upper surface; a schematic illustration of a plurality of (e.g., four) undulating waves, and/or the word “Washing” adjacently above undulating waves.

Alternatively, the wash cycle activity indicia 732 may have a particular configuration for each wash cycle segment in the wash cycle. For example, during the fill segment, the wash cycle activity indicia 732 may comprise a schematic illustration of a plurality of (e.g., four) horizontal bars that are illuminated or otherwise varied in an upwardly oriented series to schematically illustrate a filling motion and/or the word “Filling” adjacently above the bars. During the wash segment, the wash cycle activity indicia 732 may comprise a schematic illustration of a plurality of (e.g., four) undulating waves, and/or the word “Washing” adjacently above undulating waves.

Further, the pause/stop icon 40 may be actuated by the user in instances, for example, where the user wishes to add an article of clothing to the laundry appliance after a cycle has been initiated. In such instances, actuation of the pause/stop icon 40 causes the laundry appliance to halt the ongoing cycle and to configure the laundry appliance so as to allow the user to open the door assembly to add the article of clothing (i.e., for a washer, any water within the tub portion is first drained before the user is allowed to open the door assembly). Upon configuration of the laundry appliance to allow the door assembly to be opened, the display portion 200 is configured to display a “Pause” display 711, as shown in FIG. 22, which may include both a start icon 50 and a cancel icon 45. If the user wishes to simply add the article of clothing, the user does so and may actuate the start icon 50 upon completion. Upon re-starting the selected/default/favorite main wash cycle, the interrupted cycle may continue (i.e., time-wise) from the point at which it was interrupted by the user.

In other instances, instead of adding an article of clothing, the user may actuate the cancel icon 45, which causes the selected/default/favorite main wash cycle to be cancelled, and the display portion 200 returns to a display of the main menu display 210 (e.g., FIGS. 1 and 2). In any instance, completion of the selected/default/favorite main wash cycle causes the display portion 200 to replace the wash cycle status display 710 (e.g., FIGS. 13 and 14) with the main menu display 210. However, one skilled in the art will appreciate that the completion of the cycle could be indicated in various manners such as, for example, a “Cycle Completed” display presented on the display portion 200 which could be removed therefrom through a positive action required by the user, such as by actuation of an acknowledgement icon (not shown) presented on the display portion 200 or by opening the door assembly to remove the articles of clothing from the laundry appliance.

In some aspects, the Pause display 711 may also include a Cycle Settings icon 712 which may be selectable by the user, should the user decide to change any of the primary parameters or options associated with the selected/default/favorite main wash cycle. Actuation of the Cycle Settings icon 712 thus causes the cycle settings tab 510 and primary parameter icons 300 associated therewith for the particular selected/default/favorite main wash cycle to be displayed on the display portion 200. In some instances, the options display tab 410 may also be selectable by the user to change the previously selected options associated with the particular selected/default/favorite main wash cycle. If any of the primary parameters or options are changed by the user prior to actuating the start icon 50, the changed main wash cycle may be initiated from the beginning thereof (i.e., the entire changed main wash cycle is executed, instead of continuing the cycle from the point at which the previous cycle was interrupted).

As shown in FIGS. 15-18, aspects of the touchscreen user interface 150 according to the present disclosure may be configured for use with a dryer appliance. In this regard, according to some aspects, the display portion 200 may be configured to display a plurality of selectable main drying cycle icons 1250 (e.g., Normal, Heavy Duty, Express Dry, Jeans, Bulky/Bedding, Delicates, Ultra Delicate, Towels, Touch Up, Casual, Allergen, Time Dry, Casual, Kids Wear, Mixed Load, Sanitize and Steam Care) associated with a respective main drying cycle. As with the washing machine aspects, only a limited (i.e., less than the total amount of main drying cycle icons) or a predetermined amount of the main drying cycle icons 1250 may be visibly displayed as a series on the display portion 200 at any time. For example, as shown in FIG. 15, only five main drying cycle icons 1250 (Towels, Casual, Normal, Time Dry, and Jeans) of the series are displayed on the display portion 200 concurrently, while one or more other main drying cycles remain available for selection. However, the one or more main drying cycle icon 1250 may not be visibly displayed on the display portion 200. In this regard, any number of main drying cycle icons 1250 may be concurrently displayed on the display portion 200 at any time, including all available main drying cycle icons 1250 in the series. According to further aspects of the present disclosure, the main drying cycle icons 1250 may be scrollable with respect to the display portion 200, in the same or similar manner as the main wash cycle icons 250, as previously disclosed.

According to some aspects of the present disclosure, an initial selection of one of the main drying cycle icons 1250 displayed on the display portion 200 causes primary parameter icons 1300, associated with the selected main drying cycle, to be displayed on the display portion 200, as shown in FIG. 15. The primary parameter icons 1300 may be indicative of parameters common to all main drying cycles, such as, for example, the (drying) air temperature and the desired dryness level. In some instances, the primary parameter icons 1300 may be displayed adjacent to the series of main drying cycle icons 1250. For example, as shown in FIG. 15, the primary parameter icons 1300 may be displayed vertically-adjacent to a horizontal row of the selectable main drying cycle icons 1250. The primary parameter icons 1300 may be set to default values of each respective main drying cycle such that, upon selection of a particular main drying cycle by a user via the associated main drying cycle icon 1250, the primary parameter icons 1300 reflect the default values of that particular main drying cycle. For example, as shown in FIG. 15, a selection of the Normal main drying cycle icon 1256 causes the primary parameter icons 1300 to display the default values associated therewith such as, for example, an air temperature parameter icon 1260 (e.g., Med/High Temp) and a dryness level parameter icon 1262 (e.g., Normal Dryness) as the default values when the Normal main drying cycle icon 1256 is selected. The default values of the primary parameter icons 1300, associated with the main drying cycle, may be indicated using textual indicia, numerical indicia, or any other suitable indicia. Further, the primary parameter icons 1300 may display appropriate graphics (e.g., a thermometer for the air temperature parameter) for indicating to the user the particular parameter associated with the primary parameter icon 1300. According to aspects of the present disclosure, the primary parameter icons 1300 may in some instances only be displayed on the display portion 200 when the associated and initially selected main drying cycle icon 1250 is displayed on the display portion 200, as previously described with respect to the main drying cycle icons 1250.

According to some aspects of the present disclosure, an Options icon 1400 may be displayed on the display portion 200 in conjunction with a default main drying cycle, or when one of the main drying cycle icons 1250 is selected by the user. In some instances, the Options icon 1400 may be displayed on the display portion 200 adjacent to the primary parameter icons 1300. The Options icon 1400 may be actuatable to display, on the display portion 200, a plurality of selectable option icons 1450, other than the primary parameters 1300, associated with the selected main drying cycle. For example, actuation of the Options icon 1400 may cause an options tab 1410 to be displayed on the display portion 200, wherein the options tab 1410 includes the plurality of selectable option icons 1450. The selectable option icons 1450 may include, for example, a Soft Heat option icon 1452, a Damp Dry Signal option icon 1454, an Add Steam option icon 1456, and a Wrinkle Guard option icon 1458. According to some aspects, a drying cycle initiation icon 1500 may remain displayed and actuatable to initiate the selected main drying cycle when the options tab 1410 is selected and displayed.

In addition, according to some aspects, an initial selection of one of the main drying cycle icons 1250 displayed on the display portion 200 causes an auto dry icon 1700 to be displayed on the display portion 200 in conjunction with the primary parameters 1300, as shown in FIG. 15. In some instances, the auto dry icon 1700 may be displayed adjacent to the primary parameter icons 1300. The auto dry selection may not be available for use when certain main drying cycles are selected. In such instances, the auto dry icon 1700 may be grayed-out of otherwise indicated as being unavailable to be selected by the user. For example, as shown in FIG. 15, when the normal main drying cycle icon 1256 is selected, the auto dry icon 1700 is not selectable by the user, and is thus shown as being grayed out compared to the selectable primary parameter icons 1300 and the main options icon 1400. One skilled in the art will appreciate that the auto dry selection may be implemented to automatically determine when the articles of clothing in the dryer are dried, without particularly being tied to a particular cycle duration.

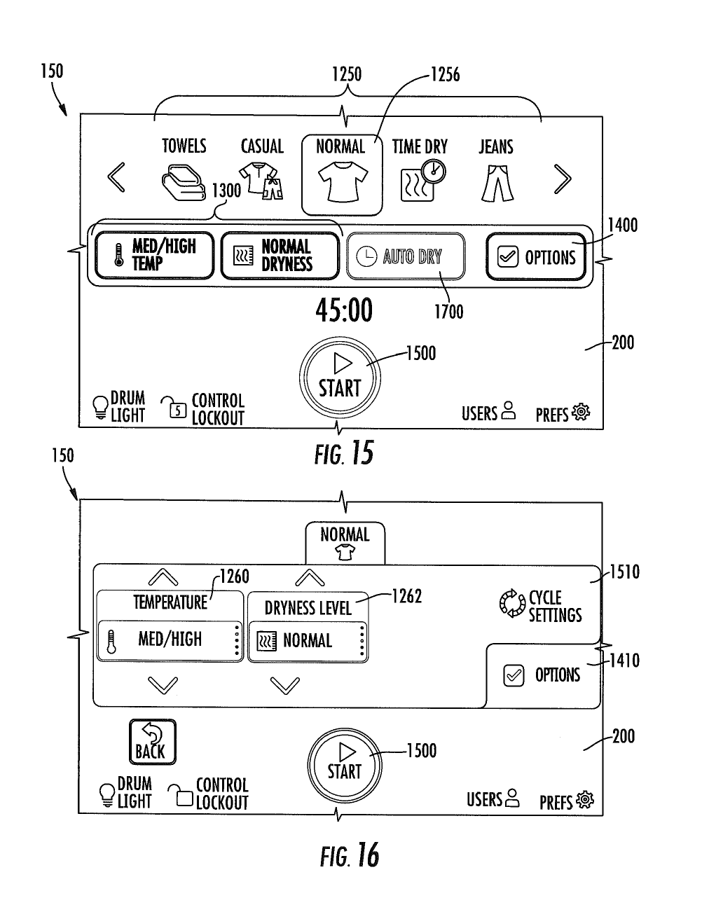

In some aspects, a selection of any one of the primary parameter icons 1300 may cause an expanded display of the primary parameters to be displayed on the display portion 200 in association with, for example, a cycle settings tab 1510, as shown in FIGS. 16 and 17. In some instances, at least a portion of the options tab 1410 may be displayed on the display portion 200 when the cycle settings tab 1510 is displayed, as shown in FIG. 16. As such, the user can interact with the displayed portion of the options tab 1410 or the cycle settings tab 1510 to toggle/switch between the cycle settings tab 1510 and the options tab 1410 for viewing/adjusting the respective parameters/options associated therewith.

Upon the user determining the parameters of a desired drying program, including the appropriate main drying cycle, and any primary parameter changes or option selections, the start icon 1500 displayed on the display portion 200 may be actuated by the user to initiate the selected main drying cycle. For example, regarding the illustration of FIG. 15, selecting or actuating the start icon 1500 would cause the selected Normal main drying cycle to be actuated. As discussed previously with respect to the washing appliance, the start icon 1500 may be user-actuated when any of the main menu display 210, the options tab 1410, and the cycle settings tab 1510 is displayed on the display portion 200.

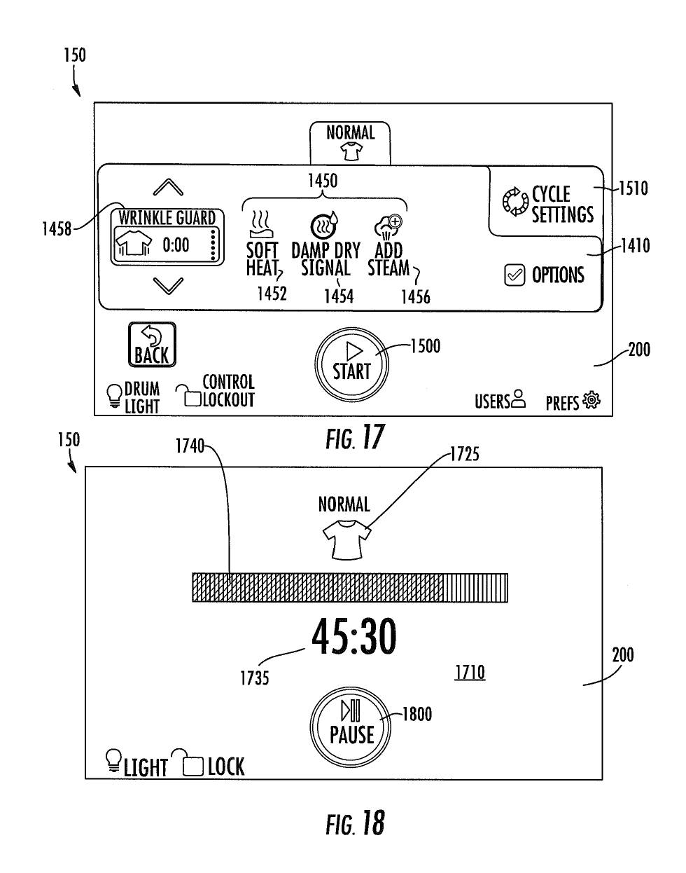

Upon actuation of the user-selected main drying cycle via the start icon 1500, a drying cycle status display 1710 may be displayed on the display portion 200, as shown in FIG. 18. In some instances, various drying cycle status indicia may be displayed on the drying cycle status display 1710. For example, the drying cycle status indicia may include an indicia of the selected main drying cycle 1725, a drying cycle countdown timer 1735, an indicia of cycle progress (i.e., elapsed time and/or time remaining) 1740, and a user-selectable pause/stop icon 1800.

As previously indicated, the disclosure provided herein related to the washing appliance touchscreen user interface 150 may also be applicable to a touchscreen user interface 150 for a dryer appliance, in addition to the disclosure related to such a dryer appliance touchscreen user interface provided herein. For example, the Options icon 1400 for the dryer appliance may include a numerical indicia associated therewith for indicating the amount of selectable options included as additional default parameters associated with the selected main drying cycle and/or any of the other selectable options selected or de-selected by the user. In a further example, the selected or default main drying cycle icon 1250 may be highlighted or otherwise visually-distinguished on the display portion 200. As such, one skilled in the art will appreciate that the functionalities of touchscreen user interfaces configured for each of a washing appliance and a dryer appliance may be substantially similar and, as such, the configurations and aspects of a washing appliance controller as disclosed herein may be substantially applicable to a dryer appliance save, for example, the identities of the main cycles and associated cycle parameters and options.

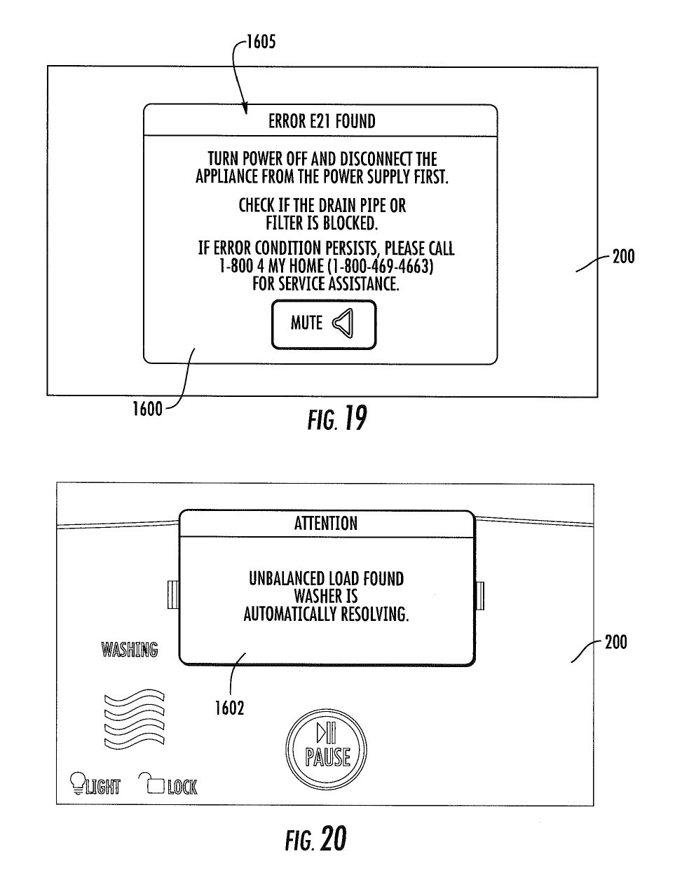

As shown in FIG. 19, the display portion 200 may also be configured to display an error message, indicating that an error has occurred during a main wash/dry cycle. The error messages may be generated by detected system events, and the error messages may be identified or otherwise referenced, for example, by an error ID number 1605. In some aspects, the error message may be displayed via an error image 1600 (e.g., a “pop-up window”) on the display portion 200. In some instances, the error image 1600 may include information for assisting the user in potentially correcting the detected error. For example, as shown in FIG. 19, the user may be instructed to turn off the main power to the washing appliance, to disconnect the washing appliance from the power supply, and then to check if the drain pipe or filter is blocked, in an attempt to allow the user to potentially rectify a detected drainage error. Other potential errors or abnormal conditions may be related to a “Door Open” condition (a warning display is presented instructing the user to close the door assembly and actuate the start icon again), an unbalanced load condition (and/or ongoing automatic re-balancing efforts—i.e., a warning display is presented notifying the user that the machine has detected an unbalanced load and is attempting to resolve automatically, for example, by executing a tumbling sequence, wherein the warning display will disappear once the load is re-balanced. If the condition is automatically resolved, a further warning display is presented notifying the user that an unbalanced condition occurred and was automatically resolved), and an sudsing (or over-sudsing) condition (and/or ongoing automatic suds-reduction efforts—i.e., if a suds condition is detected, a warning display is presented notifying the user that the condition has been detected and is being automatically resolved, wherein the warning display will disappear once the condition is resolved. If the condition is automatically resolved, a further warning display is presented notifying the user that a suds condition was detected and was automatically resolved, and may be accompanied by a message to the user suggesting future use of HE detergent to avoid the condition).

In the case of a dryer appliance, the user may be instructed, for example, to turn off the main power to the dryer appliance, to disconnect the dryer appliance from the power supply, and then to check if the dryer vent is blocked, in an attempt to allow the user to potentially rectify a detected air flow error. Other potential errors or abnormal conditions may be related to a “Door Open” condition (a warning display is presented instructing the user to close the door assembly and actuate the start icon again), an exhaust restriction condition (if a restriction in the exhaust venting system is detected during a cycle, a warning display is presented instructing the user to refer to the User & Care guide for more information. The same display may also be presented at the end of the cycle), and a failure to meet minimum load size condition (if too small of a load is detected during a cycle, a warning display is presented notifying the user of the load failing to meet a minimum size, for which a correct drying time cannot be estimated. The same display may also be presented at the end of the cycle, recommending that the user use a larger load for future cycles). In this regard, the user may be able to resolve the detected error or other abnormality issue, without requiring the user to place a service call. According to some aspects, the text of the error message may be predetermined with respect to corresponding detectable errors or abnormalities, such that the displayed text may not need to be dynamically generated or is otherwise standardized. In some instances, after power is re-connected to the laundry appliance, the user may be allowed to re-initiate operation of the main laundry cycle if the error does not recur. If the error is not resolved by the suggested corrective action, the error message may provide appropriate contact information (e.g., a service assistance number) for assisting the user.

The error image 1600 or “pop-up” window may also be implemented to call the user's attention to a particular condition or to advise the user on possible action(s) that could be taken to potentially resolve an issue. The error image 1600 may also be accompanied by an aural indicia, such as a particular chime In some instances, as shown in FIG. 20, an attention image 1602 may be distinguished from an error image in the possible steps which may be taken by the user. For example, the attention image (possibly accompanied by the aural indicia) may advise the user of various corrective steps that could be taken and allow the user to select and implement those steps. In contrast, should an error be detected, the subsequent error image 1600 may not allow the user to take any action, other than to advise the user to call for service. The detection of an error may also be accompanied by ceasing the active cycle. Further, the error image 1600 may be distinguished from an attention image 1602, for instance, by the color of the image (i.e., an error image may be distinguished by a red component, such as a header, presented in conjunction with the error code). An error image may also be accompanied by an aural indicia, such as a chime.

In addition, the touchscreen user interface 150 may include sleep/standby modes and functionalities. According to some aspects, different time out events of the touchscreen user interface 150 may occur depending on the operational status of the laundry appliance. For example, the laundry appliance may enter a standby mode after five minutes of inactivity, and then enter a sleep mode after thirty minutes of inactivity (i.e., no user interaction with the touchscreen user interface 150). In this regard, when the touchscreen user interface 150 is in the standby mode, the display portion 200 does not include a display, but remains sensitive to a user interaction therewith (i.e., the user touching the display portion 200) to cause a display to re-appear thereon in response to the user interaction. When the touchscreen user interface 150 is in the sleep mode, the display portion 200 does not include a display and, in some instances, may be powered off. In such instances, the display portion 200 may be configured to awaken and provide a display therein in response to physical actuation by the user (e.g., user-actuation of the Power button or actuator).

More particularly, in some instances, the standby mode may be actuated following about 5 minutes of inactivity. In such instances, the backlighting of the display portion 200 may be reduced to about 10%. The sleep mode may then be actuated following about 30 minutes of inactivity, wherein the backlighting of the display portion 200 may be completely shut off. The standby and sleep modes may be implemented when the touchscreen user interface is idle when displaying one of the following: home, preferences, users, cycle settings, cycle options (but not when the selected cycle is being executed). If the display portion is in the standby mode, any detected touch may restore the backlighting to a normal level. However, if the inactivity persists, and the touchscreen user interface enters the sleep mode, and the display portion 200 can be restored by actuating the power actuator for the laundry appliance.

Many modifications and other aspects of the disclosure set forth herein will come to mind to one skilled in the art to which this disclosure pertains having the benefit of the teachings presented in the foregoing descriptions and the associated drawings. For example, in some aspects, the laundry appliance may implement an install cycle or procedure, wherein such an install cycle may be implemented to determine whether the appliance was installed correctly. The duration of such a cycle may be, for example, about 6 minutes for washer and about 4 minutes for dryer. The install cycle, once initiated, may not be configured to be paused, and may only be interrupted by de-actuating the power actuator for the laundry appliance. During such an install cycle, various checks are performed by the controller device and, if a check is not passed, a warning or an alarm display is presented on the display portion 200 and the install cycle is paused. To exit from this condition, the power actuator must be de-actuated or power to the laundry appliance must be disconnected. Checks for a washing machine may include, for example, whether the water tap is open or closed, or whether the drain pipe is properly positioned. Checks for a dryer may include, for example, whether the power service cord was properly installed properly, or whether the gas service is on or off.

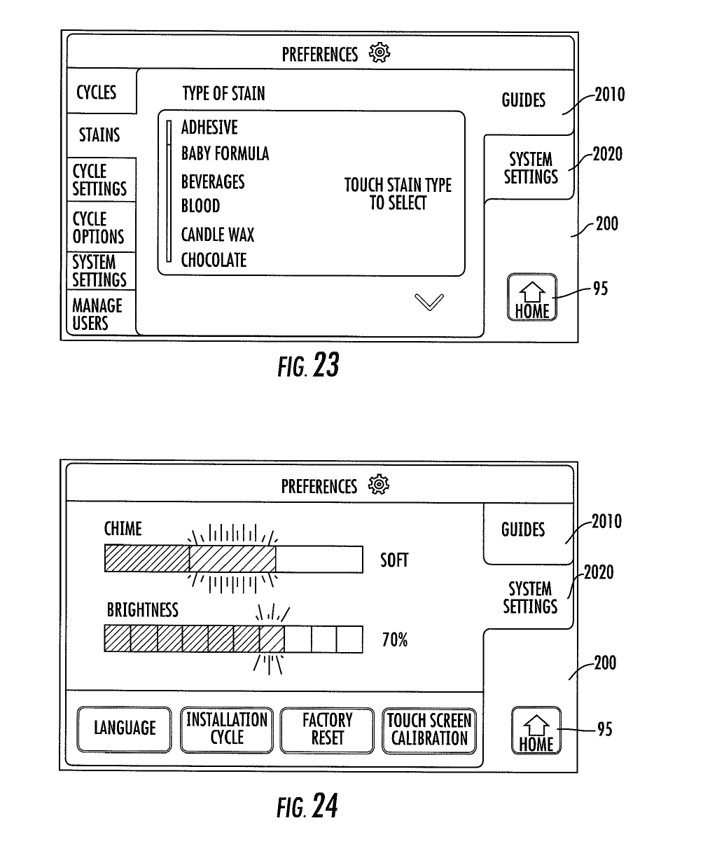

In addition, in some aspects, a preferences icon 60 (e.g., FIGS. 2-5) may be presented on the display portion 200 in conjunction with the main wash cycle icons 250. In such instances and referring to FIG. 23, user selection of the preferences icon 60 may cause the user to be presented with selectable tabs, including, for example, a guides tab 2010, and a system settings tab 2020. Under the guides tab 2010, the user may be presented with instructional guides relating to various aspects of the laundry appliance and the operation and use thereof. As shown in FIG. 24, under the system settings tab 2020, the user may be able to adjust the loudness of the aural indicia, as well as the brightness of the display portion 200. The user may also be able to, through particular icons presented in association with the system settings tab 2020, adjust the default language of the laundry appliance, perform the install cycle, reset the laundry appliance to factory settings, and calibrate the touchscreen user interface, as shown in FIG. 24.

Whereas exemplary embodiments have been described above often in the context of laundry appliances, features of this disclosure have applicability to other types of appliances, such as to a suite of kitchen and laundry appliances. Accordingly, in one aspect of this disclosure, references to “laundry” may be omitted or replaced with an identifier of another type or class of appliances, such as kitchen appliances. That is and for example, the appliances of this disclosure may be kitchen and/or laundry appliances, although other types of appliances are also within the scope of this disclosure. The kitchen appliance(s) may be one or more of an oven, stove, range, warmer, toaster, dishwasher, refrigerator, freezer, and coffee maker, or the like. The laundry appliance(s) may be one or more of a laundry washer and/or a laundry dryer, or the like. Other types of appliances are also within the scope of this disclosure.

It is to be understood that the disclosure is not to be limited to the specific aspects disclosed and that modifications and other aspects are intended to be included within the scope of the appended claims. Although specific terms are employed herein, they are used in a generic and descriptive sense only and not for purposes of limitation.

1.-13. (canceled)

14. A method of controlling a laundry appliance, comprising:
displaying a series of main laundry cycle icons on a display screen of a touchscreen user interface associated with the laundry appliance, the touchscreen user interface being in communication with a controller device configured to direct operation of at least one operational component associated with the laundry appliance in response to at least one user selection via the touchscreen user interface, each main laundry cycle icon being associated with a respective main laundry cycle capable of being implemented via the controller device and being individually selectable as one of the at least one user selection via user touch interaction with the touchscreen user interface; and
scrolling the series of main laundry cycle icons across the display screen in one of a first and second scrolling direction.

15. A method according to claim 14, wherein displaying a series of main laundry cycle icons comprises one of:
displaying a predetermined number of the main laundry cycle icons, of the series of main laundry cycle icons, on the display screen for user selection, the predetermined number of the main laundry cycle icons being less than a total number of the main laundry cycle icons in the series;
displaying a scrolling direction icon adjacent to a predetermined number of main laundry cycle icons, of the series of main laundry cycle icons, displayed on the display screen, and scrolling the series of main laundry cycle icons across the display screen comprises actuating the scrolling direction icon via user touch interaction with the touchscreen user interface to scroll the series of main laundry cycle icons in one of the first and second scrolling directions;
displaying the series of main laundry cycle icons on the display screen in a linear arrangement associated with the first and second scrolling directions;
displaying a series of main laundry cycle icons on a display screen of a touchscreen user interface associated with the laundry appliance, such that the series of main laundry cycle icons is endlessly scrollable across the display screen in one of the first and second scrolling directions;
displaying each main laundry cycle icon on the display screen as at least one of a textual indicia and a graphical indicia associated with the respective main laundry cycle;
visually-distinguishing one of the main laundry cycle icons displayed on the display screen as a default main laundry cycle icon; and
visually-distinguishing one of the main laundry cycle icons displayed on the display screen as a selected main laundry cycle icon, in response to user selection thereof via user touch interaction with the touchscreen user interface.

16. (canceled)

17. A method according to claim 14, wherein scrolling the series of main laundry cycle icons across the display screen comprises scrolling the series of main laundry cycle icons across the display screen in one of the first and second scrolling directions, in response to a directional user swipe interaction with the touchscreen user interface, in relation to the series of main laundry cycle icons.

18.-22. (canceled)

23. A method according to claim 14, further comprising displaying at least one cycle parameter on the display screen adjacent to the series of main laundry cycle icons, the at least one cycle parameter being associated with a visually-distinguished one of the main laundry cycle icons corresponding to one of a default main laundry cycle icon and a selected main laundry cycle icon.

24. A method according to claim 23, further comprising displaying a cycle start icon on the display screen, the cycle start icon being user-actuatable to direct the controller device to initiate the main laundry cycle associated with the visually-distinguished one of the main laundry cycle icons.

25. A method according to claim 23, further comprising removing the displayed at least one cycle parameter from the display screen in response to the corresponding visually-distinguished one of the main laundry cycle icons being scrolled off the display screen.

26. A method according to claim 25, further comprising displaying a cycle start icon on the display screen, the cycle start icon being user-actuatable to direct the controller device to initiate the main laundry cycle associated with the visually-distinguished one of the main laundry cycle icons, regardless of whether the visually-distinguished one of the main laundry cycle icons is displayed on the display screen.

27.-38. (canceled)

39. A method of controlling a laundry appliance, comprising:
displaying a series of main laundry cycle icons on a display screen of a touchscreen user interface associated with the laundry appliance, the touchscreen user interface being in communication with a controller device configured to direct operation of at least one operational component associated with the laundry appliance in response to at least one user selection via the touchscreen user interface, each main laundry cycle icon being associated with a respective main laundry cycle capable of being implemented via the controller device and being individually selectable as one of the at least one user selection via user touch interaction with the touchscreen user interface; and
displaying at least one cycle parameter on the display screen adjacent to the series of main laundry cycle icons, the at least one cycle parameter being associated with a visually-distinguished one of the main laundry cycle icons corresponding to one of a default main laundry cycle icon and a selected main laundry cycle icon.

40. A method according to claim 39, wherein displaying a series of main laundry cycle icons comprises displaying a predetermined number of the main laundry cycle icons, of the series of main laundry cycle icons and less than a total number of the main laundry cycle icons in the series, on the display screen for user selection, the series of the main laundry cycle icons being scrollable across the display screen in opposing first and second scrolling directions.

41. A method according to claim 40, further comprising removing the displayed at least one cycle parameter from the display screen in response to the corresponding visually-distinguished one of the main laundry cycle icons being scrolled in one of the scrolling directions so as to not be one of the predetermined number of main laundry cycle icons displayed on the display screen.

42. A method according to claim 41, further comprising displaying a start icon on the display screen, the start icon being user-actuatable to direct the controller device to initiate the main laundry cycle associated with the visually-distinguished one of the main laundry cycle icons, regardless of whether the visually-distinguished one of the main laundry cycle icons is displayed on the display screen.

43. A method according to claim 39, further comprising:
visually-distinguishing another of the main laundry cycle icons displayed on the display screen, upon selection thereof by the user, and displaying the at least one cycle parameter associated therewith; and
if a parameter value of the at least one cycle parameter of the another of the main laundry cycle icons is different from a parameter value of the corresponding at least one cycle parameter of the one of the main laundry cycle icons, scrolling through a series of parameter values associated with the at least one cycle parameter, between the respective parameter values associated with the main laundry cycle icons.

44. A method according to claim 39, wherein displaying at least one cycle parameter on the display screen comprises displaying at least one cycle parameter on the display screen as a user-actuatable cycle parameter icon having at least one of a textual indicia and a graphical indicia indicative thereof.

45. A method according to claim 39, wherein displaying at least one cycle parameter on the display screen comprises displaying at least one cycle parameter associated with one of a water temperature, a soil level, and a spin rate, each cycle parameter being associated with a water temperature level icon, a soil level parameter icon, and a spin rate parameter icon, respectively.

46. A method according to claim 44, further comprising displaying a cycle settings tab and a cycle parameter adjustment arrangement associated therewith on the display screen upon actuation of the cycle parameter icon, and displaying a scrolling direction icon of the cycle parameter adjustment arrangement adjacent to a parameter value indicia associated with the cycle parameter icon, the scrolling direction icon being user touch-actuatable to scroll through the parameter values associated with the cycle parameter icon, in one of a first and second scrolling direction.

47. A method according to claim 46, further comprising one of:
displaying a selection indicia adjacent to the parameter value indicia associated with the cycle parameter icon, the selection indicia being indicative of an amount of the parameter values in the series thereof available for the cycle parameter, and the position of the displayed parameter value in the series;
displaying a start icon on the display screen concurrently with the cycle settings tab, the start icon being user-actuatable to direct the controller device to initiate the main laundry cycle associated with the selected one of the main laundry cycle icons;
displaying a back icon on the display screen concurrently with the cycle settings tab, the back icon being user-actuatable to remove the cycle settings tab from the display screen and to display the series of main laundry cycle icons, the visually-distinguished one of the main laundry cycle icons, and the at least one cycle parameter associated therewith; and
displaying a save icon on the display screen concurrently with the cycle settings tab, if the at least one cycle parameter is changed by the user, the save icon being user-actuatable to save any changes made by the user to the at least one cycle parameter such that the changed at least one cycle parameter is implemented upon initiation of the main laundry cycle associated with the visually-distinguished one of the main laundry cycle icons.

48.-64. (canceled)

65. A method of controlling a laundry appliance, comprising:
displaying a series of main laundry cycle icons on a display screen of a touchscreen user interface associated with the laundry appliance, the touchscreen user interface being in communication with a controller device configured to direct operation of at least one operational component associated with the laundry appliance in response to at least one user selection via the touchscreen user interface, each main laundry cycle icon being associated with a respective main laundry cycle capable of being implemented via the controller device and being individually selectable as one of the at least one user selection via user touch interaction with the touchscreen user interface; and
displaying at least one primary parameter icon on the display screen adjacent to the series of main laundry cycle icons, the at least one primary parameter icon being associated with a visually-distinguished one of the main laundry cycle icons.

66. A method according to claim 65, wherein displaying at least one primary parameter icon comprises displaying at least one primary parameter icon having:
textual indicia indicative of a cycle parameter value associated with the visually-distinguished one of the main laundry cycle icons, and
graphical indicia indicative of a cycle parameter associated with the main laundry cycles.

67. A method according to claim 65, further comprising one of:
scrolling among a series of cycle parameter values, which are represented by indicia and associated with the displayed at least one primary parameter icon, in response to selection of one of the main laundry cycle icons as one of the at least one user selection via user touch interaction with the touchscreen user interface;
removing the displayed at least one primary parameter icon from the display screen in response to the visually-distinguished one of the main laundry cycle icons being scrolled off the display screen;
displaying a main options icon on the display screen, the main options icon being user-actuatable such that actuation thereof causes the touchscreen user interface to display a cycle settings tab and an options tab having a plurality of user-actuatable option icons, and further comprising displaying at least one cycle parameter associated with the visually-distinguished one of the main laundry cycle icons and removing the plurality of option icons upon user-actuation of the cycle settings tab.

68. (canceled)

69. A method according to claim 65, further comprising displaying a cycle settings tab upon user-actuation of the at least one primary parameter icon, the cycle settings tab being configured to facilitate change to a default parameter value associated with the at least one primary parameter icon.

70. A method according to claim 69, further comprising one of:
displaying a cycle start icon on the display screen concurrently with the cycle settings tab, the cycle start icon being user-actuatable to direct the controller device to initiate the main laundry cycle associated with the visually-distinguished one of the main laundry cycle icons;
displaying on the cycle settings tab a scrolling direction icon adjacent to an indicia indicative of a cycle parameter value associated with a cycle parameter of the visually-distinguished one of the main laundry cycle icons, the scrolling direction icon being actuatable via user touch interaction with the touchscreen user interface to scroll a series of the parameter values associated with the cycle parameter in one of a first and second scrolling directions;
displaying a back icon on the display screen concurrently with the cycle settings tab, the back icon being user-actuatable to remove the cycle settings tab from the display screen and to display the series of main laundry cycle icons and the at least one cycle parameter being associated with the visually distinguished one thereof;
displaying a save icon on the display screen concurrently with the cycle settings tab, the save icon being user-actuatable to save any changes made to the at least one cycle parameter such that upon initiation of the laundry cycle the selected cycle parameter is implemented.

71. (canceled)

72. A method according to claim 69, further comprising displaying a selection indicia adjacent to an indicia indicative of a cycle parameter value associated with the cycle parameter of the visually-distinguished one of the main laundry cycle icons, the selection indicia being indicative of selectable parameter values available for the cycle parameter.

73. A method according to claim 72, wherein displaying a selection indicia comprises displaying a selection indicia comprising a series of lightable elements, and further comprising displaying one of the lightable elements corresponding to a current selectable parameter value as lit so as to indicate the current selectable value, the other of the lightable elements being configured to be lit in response to the selection of a different selectable parameter value.

74.-75. (canceled)

76. A method according to claim 69, further comprising displaying an options tab concurrently with the cycle settings tab, the options tab being configured to facilitate change to a plurality of options associated with the visually-distinguished one of the main laundry cycle icons.

77. A method according to claim 76, further comprising displaying a plurality of options icons and removing cycle parameter values upon user-actuation of the options tab.

78.-88. (canceled)

89. A method of controlling a laundry appliance, comprising:
displaying a series of main laundry cycle icons on a display screen of a touchscreen user interface associated with the laundry appliance, the touchscreen user interface being in communication with a controller device configured to direct operation of at least one operational component associated with the laundry appliance in response to at least one user selection via the touchscreen user interface, each main laundry cycle icon being associated with a respective main laundry cycle capable of being implemented via the controller device and being individually selectable as one of the at least one user selection via user touch interaction with the touchscreen user interface;
displaying a cycle start icon on the display screen, the cycle start icon being user-actuatable; and
actuating the cycle start icon to direct the controller device to initiate the main laundry cycle associated with a visually-distinguished one of the main laundry cycle icons corresponding to one of a default main laundry cycle icon and a selected main laundry cycle icon.

90. A method according to claim 89, further comprising displaying a wash cycle status display on the display screen, in response to actuation of the cycle start icon via user touch interaction with the touchscreen user interface.

91. A method according to claim 90, further comprising displaying a pause icon on the wash cycle status display, the pause icon being user-actuatable to direct the controller device to pause operation of the main laundry cycle associated with the visually-distinguished one of the main laundry cycle icons.

92. A method according to claim 91, further comprising displaying a pause display on the display screen, in response to actuation of the pause icon via user touch interaction with the touchscreen user interface.

93. A method according to claim 92, further comprising displaying the cycle start icon and a cancel icon on the pause display, the cycle start icon being user-actuatable to direct the controller device to re-initiate the main laundry cycle associated with the visually-distinguished one of the main laundry cycle icons, and the cancel icon being user-actuatable to direct the controller device to cancel the main laundry cycle associated with the visually-distinguished one of the main laundry cycle icons.

94. A method according to claim 93, further comprising, in response to actuation of the cancel icon via user touch interaction with the touchscreen user interface:
removing the pause display from the display screen, and
displaying the series of main laundry cycle icons and the cycle start icon on the display screen.

95. A method according to claim 92, further comprising displaying a cycle settings icon on the pause display, the cycle settings icon being user-actuatable to cause the touchscreen user interface to display a cycle settings tab having at least one primary parameter icon associated therewith for changing at least one cycle parameter associated with the visually-distinguished one of the main laundry cycle icons.

96. A method according to claim 90, further comprising displaying at least one wash cycle status indicia on the wash cycle status display, the at least one wash cycle status indicia being selected from the group consisting of a selected main wash cycle indicia, a main wash cycle segment indicia, a wash cycle segment activity indicia, a wash cycle timer indicia, and a cycle progress indicia.

97. A method according to claim 90, wherein displaying the wash cycle status display comprises displaying at least one wash cycle status indicia comprising at least one of a textual indicia, a static graphical indicia, and an animated graphical indicia.

98. A method according to claim 89, wherein displaying a series of main laundry cycle icons comprises displaying a series of main laundry cycle icons that is scrollable across the display screen in opposing first and second scrolling directions, the method further comprises removing the visually-distinguished one of the main laundry cycle icons from the display screen in response to scrolling via user touch interaction with the touchscreen user interface, and the cycle start icon being user-actuatable to direct the controller device to initiate the main laundry cycle associated with the visually-distinguished one of the main laundry cycle icons while the visually-distinguished one of the main laundry cycle icons is not displayed on the display screen.

99.-115. (canceled)

116. A method of controlling a laundry appliance, comprising:
displaying a series of main laundry cycle icons on a display screen of a touchscreen user interface associated with the laundry appliance, the touchscreen user interface being in communication with a controller device configured to direct operation of at least one operational component associated with the laundry appliance in response to at least one user selection via the touchscreen user interface, each main laundry cycle icon being associated with a respective main laundry cycle capable of being implemented via the controller device and being individually selectable as one of the at least one user selection via user touch interaction with the touchscreen user interface; and
displaying a main options icon on the display screen adjacent to the series of main laundry cycle icons, the main options icon being associated with a visually-distinguished one of the main laundry cycle icons.

117. A method according to claim 116, further comprising displaying at least one primary parameter icon on the display screen adjacent to the series of main laundry cycle icons, the at least one primary parameter icon being associated with the visually-distinguished one of the main laundry cycle icons.

118. A method according to claim 116, wherein displaying a series of main laundry cycle icons comprises displaying a predetermined number of the main laundry cycle icons of the series of main laundry cycle icons, and less than a total number of the main laundry cycle icons of the series of main laundry cycle icons, on the display screen for user selection, the series of the main laundry cycle icons being scrollable across the display screen in opposing first and second scrolling directions, and further comprising removing the main options icon from the display screen in response to the visually-distinguished one of the main laundry cycle icons being scrolled in one of the scrolling directions so as to not be one of the predetermined number of main laundry cycle icons displayed on the display screen.

119. A method according to claim 116, further comprising displaying an options tab upon actuation of the main options icon, the options tab being configured to facilitate selection of at least one option associated with the main laundry cycle associated with the visually-distinguished one of the main laundry cycle icons.

120. A method according to claim 119, further comprising displaying a cycle start icon on the display screen concurrently with the options tab, the cycle start icon being user-actuatable to direct the controller device to initiate the main laundry cycle associated with the visually-distinguished one of the main laundry cycle icons.

121. A method according to claim 119, further comprising displaying a plurality of option icons on the options tab, the option icons being actuatable via user touch interaction with the touchscreen user interface to select a laundry option associated with one of the option icons so as to implement the selected laundry option in the main laundry cycle associated with the visually-distinguished one of the main laundry cycle icons.

122. A method according to claim 121, further comprising one of:
visually-distinguishing one of the option icons displayed on the display screen as a selected option icon, in response to user selection of the one of the option icons via user touch interaction with the touchscreen user interface;
displaying a numerical indicia on the options tab, the numerical indicia being indicative of a number of option icons selected via user touch interaction with the touchscreen user interface;
visually-distinguishing a non-selectable one of the option icons on the display screen;
visually-distinguishing at least one of the option icons displayed on the display screen as a default option icon; and
displaying each option icon on the display screen as at least one of a textual indicia and a graphical indicia associated with the respective laundry option.

123.-126. (canceled)

127. A method according to claim 119, further comprising one of:
displaying a delay start option icon on the options tab, the delay start option icon have at least one directional icon actuatable via user touch interaction with the touchscreen user interface to one of increase and decrease a time delay in the initiation of the main laundry cycle associated with the visually-distinguished one of the main laundry cycle icons;
displaying a back icon on the display screen concurrently with the options tab, the back icon being user-actuatable to remove the options tab from the display screen and to display the series of main laundry cycle icons;
displaying a save icon on the display screen concurrently with the options tab, the save icon being user-actuatable to save any changes made to laundry options such that upon initiation of the main laundry cycle associated with the visually-distinguished one of the main laundry cycle icons the changes made to the laundry options are implemented;
displaying a cycle settings tab concurrently with the options tab, the cycle settings tab being configured to facilitate changes to at least one cycle parameter associated with the main laundry cycle associated with the visually-distinguished one of the main laundry cycle icons;
displaying at least one primary parameter icon and removing the option icons from the display screen when the cycle settings tab is actuated; and
displaying at least one primary parameter icon on the display screen, the at least one primary parameter icon being user-actuatable such that actuation of the at least one primary parameter icon causes the touchscreen user interface to display an options tab and a cycle settings tab having a plurality of cycle parameter icons, and further comprising displaying a plurality of option icons associated with the main laundry cycle associated with the visually-distinguished one of the main laundry cycle icons and to removing the at least one primary parameter icon from the display screen upon user-actuation of the options tab.

128.-144. (canceled)

145. A method of controlling a laundry appliance, comprising:
displaying a series of main laundry cycle icons on a display screen of a touchscreen user interface associated with the laundry appliance, the touchscreen user interface being in communication with a controller device configured to direct operation of at least one operational component associated with the laundry appliance in response to at least one user selection via the touchscreen user interface, each main laundry cycle icon being associated with a respective main laundry cycle capable of being implemented via the controller device and being individually selectable as one of the at least one user selection via user touch interaction with the touchscreen user interface;
displaying a main options icon and at least one primary parameter icon on the display screen adjacent to the series of main laundry cycle icons; and
display an options tab and a cycle settings tab in response to user actuation of the main options icon and the at least one primary parameter icon, respectively, via the touchscreen user interface.

146. A method according to claim 145, further comprising concurrently displaying the options tab and the cycle settings tab such that a user is capable of toggling between the options tab and the cycle settings tab via user touch interaction with the options tab and the cycle settings tab.

147. A method according to claim 145, wherein displaying a series of main laundry cycle icons one of:
comprises visually-distinguishing one of the main laundry cycle icons displayed on the display screen, and displaying a series of main laundry cycle icons further comprises displaying a predetermined number of the main laundry cycle icons of the series of main laundry cycle icons, and less than a total number of the main laundry cycle icons of the series of main laundry cycle icons, on the display screen for user selection, the series of the main laundry cycle icons being scrollable across the display screen in opposing first and second scrolling directions, and further comprising removing the main options icon and the at least one primary parameter icon from the display screen in response to the visually-distinguished one of the main laundry cycle icons being scrolled in one of the scrolling directions so as to not be one of the predetermined number of main laundry cycle icons displayed on the display screen; and
comprises visually-distinguishing one of the main laundry cycle icons displayed on the display screen, and the options tab is configured to facilitate selection of at least one option associated with the main laundry cycle associated with the visually-distinguished one of the main laundry cycle icons.

148. (canceled)

149. A method according to claim 145, wherein the cycle settings tab is configured to facilitate change to a default parameter value associated with the at least one primary parameter icon.

150. A method according to claim 146, further comprising one of:
displaying a cycle start icon on the display screen concurrently with the options tab and the cycle settings tab, the cycle start icon being user-actuatable to direct the controller device to initiate the main laundry cycle associated with a selected one of the main laundry cycle icons; and
displaying a back icon on the display screen concurrently with the options tab and the cycle settings tab, the back icon being user-actuatable to remove the options tab and the cycle settings tab from the display screen and to display the series of main laundry cycle icons.

151. A method according to claim 145, further comprising displaying a plurality of option icons on the options tab, the option icons being actuatable via user touch interaction with the touchscreen user interface to select a laundry option associated with one of the option icons so as to implement the selected laundry option in the main laundry cycle of a selected one of the main laundry cycle icons.

152. A method according to claim 151, further comprising visually-distinguishing one of the option icons displayed on the display screen as a selected option icon, in response to user selection of the one of the option icons via user touch interaction with the touchscreen user interface.

153. A method according to claim 145, further comprising displaying on the cycle settings tab a scrolling directional icon adjacent to an indicia indicative of a cycle parameter value associated with a cycle parameter of a selected main laundry cycle, the scrolling direction icon being actuatable via user touch interaction with the touchscreen user interface to scroll a series of parameter values associated with the cycle parameter in one of a first and second scrolling directions.

154. (canceled)

155. A method according to claim 146, further comprising displaying a save icon on the display screen concurrently with the options tab and the cycle settings tab, the save icon being user-actuatable to save any changes made to at least one of a plurality of selectable option icons and a cycle parameter value associated with the primary parameter icon such that upon initiation of a selected main laundry cycle the changes are implemented.

156. A method according to claim 155, further comprising displaying a user favorite icon in the series of main laundry cycle icons, the user favorite icon being associated with any changes implemented to the selected main laundry cycle, in response to user-actuation of the save icon.

157.-158. (canceled)
